(19) United States
(12) Patent Application Publication
(10) Pub. No.: US 2008/0056184 A1
(43) Pub. Date: Mar. 6, 2008

(54) METHOD AND APPRATUS FOR PROVIDING RESOURCE ALLOCATION USING UTILITY-BASED CROSS-LAYER OPTIMIZATION

(76) Inventor: Marilynn Green, Coppell, TX (US)

Correspondence Address: DITTHAVONG MORI & STEINER, P.C., 918 Prince St., Alexandria, VA, 22314, US

(21) Appl. No.: 11/848,724

(22) Filed: Aug. 31, 2007

Related U.S. Application Data
(60) Provisional application No. 60/841,319, filed on Aug. 31, 2006.

(51) Int. Cl. H04Q 7/00; H04L 12/28

(52) U.S. Cl. 370/329; 370/344; 370/412

(57) ABSTRACT

An approach is provided for allocating resources in a communication system. Queuing state information of a queue and channel state information of a channel of a wireless network are determined. Transmission resources are allocated to wireless devices. Each device is configured to operate over the wireless network, wherein the allocation is performed according to a utility-based cross-layer resource management framework that transforms a utility function into an equivalent bipartite graph to concurrently maximize throughput and fairness in servicing the queue.

### RELATED APPLICATIONS

This application claims the benefit of the earlier filing date under 35 U.S.C. § 119(e) of U.S. Provisional Application Ser. No. 60/841,319 filed Aug. 31, 2006, entitled “Method and Apparatus For Providing Resource Allocation Using Utility-Based Cross-Layer Optimization,” the entirety of which is incorporated herein by reference.

### BACKGROUND

Radio communication systems provide users with the convenience of mobility along with a rich set of services and features. This convenience has spawned significant adoption by an ever growing number of consumers as an accepted mode of communication for business and personal uses in terms of communicating voice and data (including textual and graphical information). A continual challenge in such communication systems involve allocating resources, while minimizing transmission power levels and ensuring fairness among the users (or terminals). These parameters and competing interests result in a computationally “hard” problem.

### SOME EXEMPLARY EMBODIMENTS

Therefore, there is a need for an approach to provide a method and system for efficiently allocating resources in a communication system. A utility-based resource management scheme is provided by exploiting optimal queue and channel state information using a scheduler associated with an algorithm, to schedule optimized traffic with minimum transmit power during communications.

According to one embodiment of the invention, a method comprises determining queuing state information of a queue. The method also comprises determining channel state information of a channel of a wireless network; and allocating transmission resources to a plurality of wireless devices based on the queuing state information and the channel state information. Each of the wireless devices is configured to operate over the wireless network. The allocation is performed according to a utility-based cross-layer resource management framework that transforms a utility function into an equivalent bipartite graph to concurrently maximize throughput and fairness in servicing the queue.

According to another embodiment of the invention, an apparatus comprises a queue; a channel conditioner configured to determine channel state information of a channel of a wireless network. The apparatus also comprises a scheduler configured to allocate transmission resources to a plurality of wireless devices, configured to operate over the wireless network, based on state information of the queue and the channel state information. The allocation is performed according to a utility-based cross-layer resource management framework that transforms a utility function into an equivalent bipartite graph to concurrently maximize throughput and fairness in servicing the queue.

According to yet another embodiment of the invention, a method comprises receiving a resource allocation over a wireless network, wherein the resource allocation is among a plurality of resource allocations performed according to a utility-based cross-layer resource management framework that transforms a utility function into an equivalent bipartite graph to concurrently maximize throughput and fairness in servicing a queue. The resource allocation is based on the queuing state information and channel state information correspond to a channel of the wireless network.

According to an exemplary embodiment, an apparatus comprises a processor configured to receive a resource allocation over a wireless network, wherein the resource allocation is among a plurality of resource allocations performed according to a utility-based cross-layer resource management framework that transforms a utility function into an equivalent bipartite graph to concurrently maximize throughput and fairness in servicing a queue. The resource allocation is based on the queuing state information and channel state information correspond to a channel of the wireless network.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of allocating transmission resources based on channel state, queuing state, and/or transmission power levels, in accordance with an embodiment of the invention;

FIGS. 2A and 2B are flowcharts of processes for providing resource allocation, in accordance with various embodiments of the invention;

FIG. 3A is an example of a bipartite graph with two matchings, in accordance with an embodiment of the invention;

FIG. 3B is an example of a bipartite graph and associated maximum-weight matching, in accordance with an embodiment of the invention;

FIG. 4A is an illustration of matched/free vertices and alternating paths on a graph, in accordance with an embodiment of the invention;

FIG. 4B is an example of alternating trees on complete bipartite graph, in accordance with an embodiment of the invention;

FIG. 4C shows a feasible labeling 1, and an equality graph Gₗ, in accordance with an embodiment of the invention;

FIG. 5 is an example of packet, symbol-block and variable-length frame structures, in accordance with an embodiment of the invention;

FIG. 6 is a example of mapping of a user's signal-to-noise ratio packet capacity for the kth sub-carrier, in accordance with an embodiment of the invention;

FIG. 7 is an example of queuing system model, in accordance with an embodiment of the invention;

FIG. 8 is an example of an equivalent bipartite graph construction for optimal cross-layer resource allocation, in accordance with an embodiment of the invention;

FIG. 9 is an example of an initial graph with a feasible labeling scheme, in accordance with an embodiment of the invention;

FIG. 10 is an exemplary equality graph, in accordance with an embodiment of the invention; and

FIGS. 11-19 are diagrams illustrating the analytical framework used to provide resource allocation, according to various embodiments of the invention;

FIG. 20 is a diagram of hardware that can be used to implement an embodiment of the invention;

FIGS. 21A and 21B are diagrams of different cellular mobile phone systems capable of supporting various embodiments of the invention;

FIG. 22 is a diagram of exemplary components of a mobile station capable of operating in the systems of FIGS. 21A and 21B, according to an embodiment of the invention; and

FIG. 23 is a diagram of an enterprise network capable of supporting the processes described herein, according to an embodiment of the invention.

### DESCRIPTION OF PREFERRED EMBODIMENTS

An apparatus, method, and software for providing resource allocation in a communication network are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless packet data network, it is recognized by one of ordinary skill in the art that the embodiments of the inventions have applicability to any type of communication system and other equivalent data transmission structures.

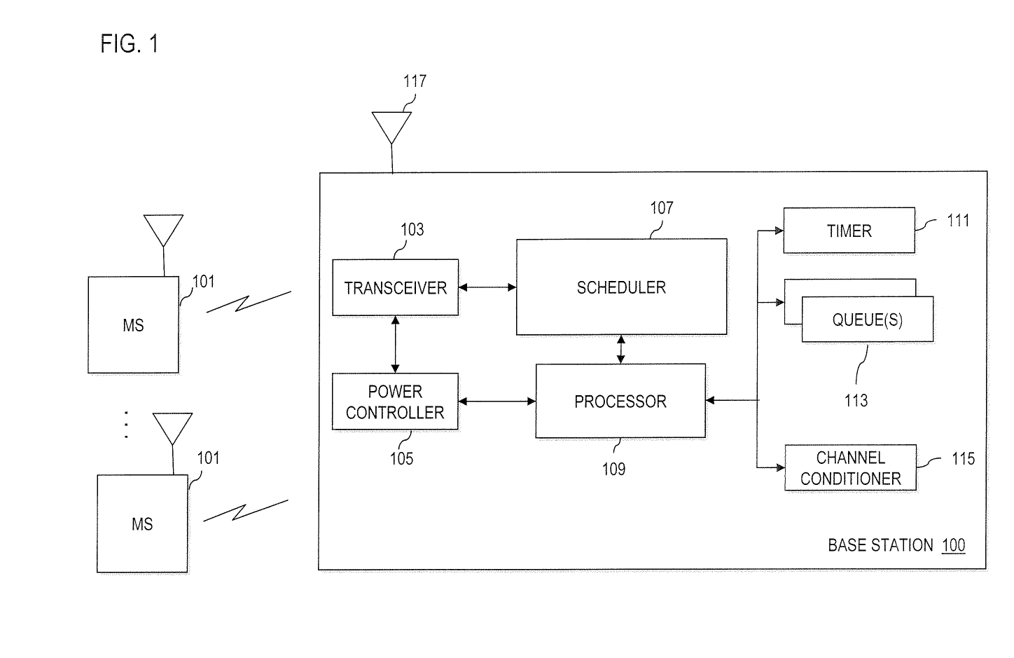

FIG. 1 is a diagram of the architecture of a base station capable of allocating transmission resources based on channel state, queuing state, and/or transmission power levels, in accordance with an embodiment of the invention. As seen in the FIG. 1, a base station (BS) 100 includes a scheduler 107 that can schedule packets for transmission to one or more mobile stations (MS) 101 or user equipment (UE) via transceiver 103 according to a resource allocation scheme executed by the processor 109. By way of example, the MS 101 can be any type of mobile stations, such as handsets, terminals, stations, units, devices, or any type of interface to the user (such as “wearable” circuitry, etc.). For example, the processor 109 can consider long-term average service rates (packet throughputs), queue occupancies (time and length) and minimum required transmit power, to efficiently communicate over a radio communication network, such as an OFDMA (Orthogonal Frequency Division Multiple Access) system.

As shown in FIG. 1, the base station 100 includes a power controller 105 to set the transmission power levels of the transceiver 103. The processor 109 couples with a number of components, such as a timer 111, one or more queues (i.e., buffer) 113 and a channel conditioner 115. The timer 111 tracks the packets that are stored in the buffers 113. The buffers 113 represent the quantity (length) of the data stream actually occupied in the queue buffers 113. In this regard, the timer 111 and buffer 113 can determine a queue state (i.e., backlog or packet waiting time) based on, for instance, the long-term average packet throughputs for providing utility-based cross-layer optimization in a wireless network.

The channel conditioner 115 is configured to detect channel condition, and also to perform necessary baseband processing, including processing any digitized received signal to extract the information or data bits conveyed in the received signal, typically including demodulation, decoding, and error correction operations. Alternatively, feedback can be used from sub-carrier channel measurements taken by the mobiles in order to estimate the channel for scheduling purposes.

In this exemplary embodiment, each sector of antenna array 117 comprises multiple antenna elements that enable antenna array 117 to use well-known beamforming techniques to implement multiple access signal over the OFDMA channels, for example, communicating concurrently in the same frequency bandwidth to multiple spatially separated subscribed mobile stations 101 using independent spatially directed beams.

Traditionally, significant focus has been placed on instantaneous throughput maximization at each decision period (or epoch) to address the multi-user water-filling problem that achieves Shannon capacity under power constraints at each decision epoch. The approach is throughput-optimal in both the short and long term when each user has an infinite or sufficient amount of data in the buffer. However, when the user does not have sufficient data in the buffer, this approach actually fails to consider the impact of the allocation decision to the future state of the system. By contrast, the approach, according to certain embodiments of the invention, provides realistic resource allocation policies in consideration of queue occupancies.

Other conventional systems are more fully described in G. Song and Y. (G.) Li, entitled “Cross-layer optimization for OFDM wireless networks Part I—theoretical framework,” IEEE Trans. On Commun., vol. 4, No. 1, March 2005, pp. 614-624[1]; G. Song and Y. (G.) Li, entitled “Cross-layer optimization for OFDM wireless networks Part II—Algorithm Development,” IEEE Trans. On Commun., vol. 4, No. 1, March 2005, pp. 625-634[2]; S. Kittipiyakul and T. Javidi, entitled “A fresh look at subcarrier allocation in OFDMA systems,” 43^{rd} IEEE Conference on Decision and Control, Volume 3, pp. 3289-3294, December 2004[3]; Z. Jiang, Y Ge and Y. (G.) Li, entitled “Max-utility wireless resource management for best effort traffic,” IEEE Transactions on Communications, vol. 47, no. 6, pp. 884-895, June 1999. [4]; all of which are incorporated herein by reference in their entireties.

Generally, with wireless applications, a reliable data transmission rate, r, is the most important factor in determining the satisfaction of users. Therefore, a utility function of the data rates, U(r), should be a non-decreasing function of its argument, as it measures the user's satisfaction with his assigned data rate. In particular, in traditional network optimization, where the objective is to maximize the aggregate throughput, the utility is a linear function of the data rate—i.e., U(r)=r. However, in general, a utility function is simply a concave “nonlinear” function of the data rate or other, measurable network resources (such as transmit power level).

The utility functions can serve as an optimization objective for the adaptive physical and MAC layer techniques. Consequently, they can be used to optimize radio resource allocation for different applications and to bridge the physical, MAC, and higher layers. In practice, utility functions cannot always be obtained through theoretical derivations, but may be estimated from subjective surveys. For example, for best effort traffic, a well-accepted utility function that is derived based on survey material is
U(r)=0.16+0.8 ln(r−0.3) (1)

where r is in units of k b/s.

In order to prevent assigning too much resource to the user with good channel conditions, the utility function is typically selected such that its slope decreases with an increase in the data rate. This prevents users that have been assigned a high proportion of the network resources from always receiving at the same level—thereby providing a mechanism to balance access amongst all users.

In the conventional case, for which U(r)=r and the goal is to maximize the sum throughput

$${\sum }_{i ∈ Θ} {r}_{i}$$

for all users that are in the active set, i ε Θ, the slope of the utility curve is a constant value of one for each user (i.e. U′(r)=1). Consequently, for a fixed transmit power level, maximum-utility is achieved by assigning each sub-carrier to the user with the best channel quality, which may result in a long-term policy that unfairly allocates resources to users who typically have good channel quality and starve those users whose channel conditions are systematically less favorable (e.g., those user who are located at the cell edge). However, it is the “derivative” of the utility function, U′(rᵢ) that actually controls the threshold of comparison for the distribution of resources. Hence, by using a non-linear utility function whose slope decreases with an increase in of the desired service, a more equitable resource distribution policy can be constructed.

The invention, according to certain embodiments, provides an improvement over the conventional systems by considering a more practical transmission scheme in which the packets from multiple users can be, for instance, time-multiplexed for transmission over the same sub-carrier during each downlink frame. Adaptive modulation and encoding is used to determine the coding rate for each packet, which depends on the channel quality of each user. Hence, each downlink frame may include a variable number of symbols.

An approach is provided for addressing the problem of how to fairly and efficiently allocate resources (sub-carriers) in a radio communication system, such as an OFDMA (Orthogonal Frequency Division Multiple Access) system, in order to simultaneously maximize the long-term average packet throughput and fairly service the user's queues. In addition, the approach can also be utilized to determine the minimum transmit power necessary to reliably send the packets during each downlink OFDMA frame.

OFDMA, also referred to as Multi-User-OFDM, is being considered as a modulation and multiple access method for 4^{th} generation wireless networks. OFDMA is an extension of Orthogonal Frequency Division Multiplexing (OFDM), which is currently the modulation of choice for high speed data access systems such as IEEE 802.11a/g wireless LAN (WiFi) (Wireless Fidelity) and IEEE 802.16a/d/e wireless broadband access systems (WiMAX) (Worldwide Interoperability for Microwave Access). OFDMA allows multiple users to transmit simultaneously on the different subcarriers.

In other words, certain exemplary embodiments of the invention provide resource allocation and scheduling for an OFDMA broadband wireless network through a utility-based cross-layer resource management framework that exploits queue and channel state information at the base station in order to schedule best effort traffic during each frame. For example, during each decision epoch, an efficient and fair sub-carrier allocation policy is determined for maximizing a concave utility function of the long-term average service rates (packet throughputs), queue occupancies and minimum required downlink transmit power. That is, the joint optimization problem of downlink transmit power, fair queue servicing and sub-carrier allocation is considered.

As will be made more apparent later, various exemplary embodiments of the invention address a utility-based maximum weighted matching on a bipartite graph, wherein queue occupancy or waiting times can be taken into account. In addition, the problem of determining the downlink power control is also addressed. The invention, according to certain embodiments, offers flexibility that can be readily used by an OFDMA system in which multiple packets from different users (at possibly different coding rates) can be concatenated and transmitted during a single frame by the same sub-carrier.

Various exemplary embodiments of the invention provide certain key properties of the utility function that allows us to substitute a maximum weight matching optimization for the nonlinear combinatorial cross layer optimization problem. The resulting flexibility in the graph-theoretic problem space allows for consideration of a downlink scenario in which the scheduler 107 can assign multiple packets to be sent to different users over each sub-carrier during each OFDMA frame. In addition, this alternate construction permits taking queue occupancy/packet waiting times naturally into consideration. The invention, according to certain embodiments, allows different packets to be weighted individually, (for example, according to waiting time in the queue).

In accordance with one embodiment, a utility-based cross-layer PHY (Physical Layer) transceiver design and MAC (Media Access Control) scheduling framework is provided for maximizing system throughput. This approach, for example, can be applied the IEEE 802.16e (“WiMAX”) (Worldwide Interoperability for Microwave Access) standards and other (such as 3.9G) standards.

While some examples of the invention may relate most particularly to down link, the examples of the invention are not restricted for use with downlink for WiMAX OFDMA wireless networks, and are generally applicable to other types of networks. The invention, in exemplary embodiments, may also be used, with certain modifications that are known to those skilled in the art, for uplink applications as well.

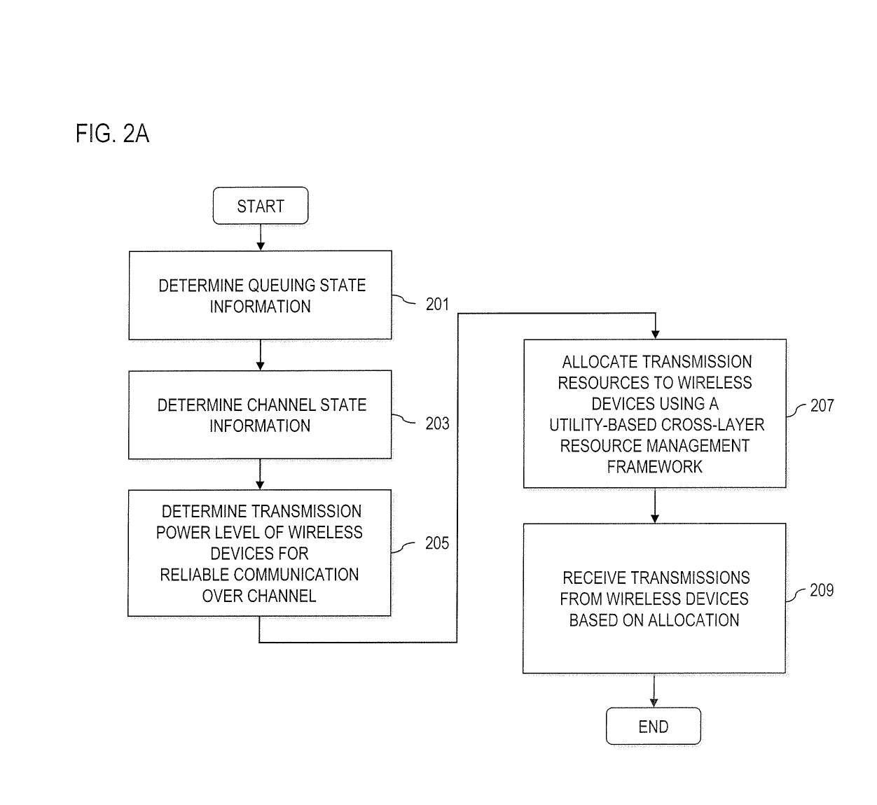

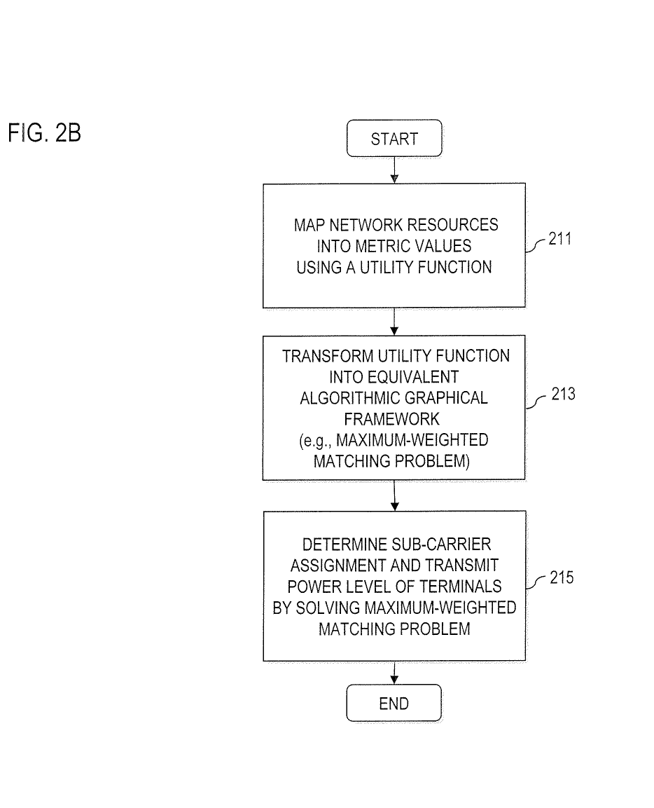

FIGS. 2A and 2B are flowcharts of processes for providing resource allocation, in accordance with various embodiments of the invention. Conventional adaptive modulation coding (AMC) schemes rely on the assumption that data is continuously available at the transmitter. However, in practical communication systems with randomly arriving data streams, the queue buffers 113 may be empty from time to time or may experience significant backlog—and thus an increase in the wait time. Hence, it is also important to consider the impact of the queue state.

Accordingly, in step 201, queuing state information is determined for consideration in the resource allocation procedure. In addition, the channel state information is determined, per step 203. Further, transmission power levels of the mobile stations 101 for reliable communications can also be factored in the resource allocation process (step 205). Next, the transmission resources (e.g., sub-carriers) are allocated, as in step 207, based on these determined factors (i.e., queuing state and channel state, and optionally transmission power levels). The mobile stations 101 subsequently transmit data over the allotted sub-carriers (step 209).

The process, in according with some embodiments, modifies the utility framework so that the scheduler 107 can fairly allocate sub-carriers in consideration of channel conditions and queue states (backlog or packet waiting time). Namely, an analytical framework for constructing an equivalent graph theoretical approach is developed to provide utility-based sub-carrier allocation. Such dual problem construction provides a natural mechanism by which queue state and transmit power information can also be exploited in the decision framework—i.e., construction of the utility-based optimization problem as an equivalent problem of Maximum Weight Matching on a bipartite graph. This approach provides a new solution space for algorithm development beyond non-linear optimization or linear programming. This approach turns an NP (Nondeterministic Polynomial)-hard problem into a problem that can be solved in polynomial time.

It is noted that many conventional approaches have been proposed to address the problem of resource allocation and scheduling for the downlink of an OFDMA broadband wireless network in which each sub-carrier can be used to transmit a variable number of packets to multiple users within each downlink frame. The packets that arrive at the base station 100 for the users are separately queued, so that each queue is associated with one and only one user. Once scheduled for transmission over a particular sub-carrier, the packets from multiple users are retrieved from the queues and then multiplexed, to be sent over the selected sub-channel during the next downlink frame. The number of packets that can be sent to any user over any particular sub-carrier is jointly determined by the channel quality and the transmit power level that is allocated to each sub-carrier.

As mentioned, during each decision epoch, an efficient and fair sub-carrier allocation policy is determined as to maximize a concave utility function of the long-term average service rates (packet throughputs for the users) and queue occupancies under constraints on the maximum power that can be used over each sub-carrier. Once the allocation is made, the minimum transmit power for reliably sending the packets over the channel, and the corresponding channel coding rate, is determined.

By way of example, the cross-layer optimization mechanism considers key aspects of the PHY and MAC layers to provide resource allocation in the network. Under this framework, the resource allocation is performed in a manner that optimally balances the fairness and efficiency of the allocation policy. In an OFDMA wireless network, this is a non-linear optimization problem which, ultimately, can result in the optimal sub-carrier assignment to different users, the determination of the uplink/downlink transmit power levels and the assignment of data rates, as well as other allocations.

According to an embodiment for implementing utility based cross-layer optimization, a utility function maps the network resources that a user utilizes into a real number that can be used as a metric to quantify this satisfaction. In this report, a utility function is used for the cross-layer optimization and for balancing the efficiency and fairness of wireless network resource allocation in an OFDMA wireless network.

The process of FIG. 2A provides a utility-based cross-layer resource management framework that exploits queue and channel state information at the base station in order to schedule best effort traffic during each frame (i.e. remove packets from the user's queue and schedule them for time-multiplexed transmission over the sub-carriers); and to determine the appropriate transmit power levels that should be used on each sub-carrier. It is important to note that the resource allocation procedure, according to one embodiment, accounts for variable packet-length frames and the time-multiplexing of packets destined for different users over a single sub-carrier. For instance, this general framework can be utilized to solve a problem in which the transmit power levels are already pre-determined, or a problem in which only a subset of the current state variables are considered: for example, the “sub-problem” of how to allocate the sub-carriers can be addressed with no regard for queue state or transmit power level.

As seen in the FIG. 2B, in step 211, network resources (e.g., sub-carriers) can be mapped into metric values using a utility function. In step 213, the process transforms the utility function into an equivalent algorithmic graphical framework (e.g., maximum-weighted matching problem). In the system 100, the processor 109 can determine, per step 205, sub-carrier assignment and transmit power level of terminals by solving maximum weighted matching problem.

The approach converts an NP-hard problem into one that is solvable in O(|V|³) time (where V denotes the number of vertices in the equivalent bipartite graph). This scheme also reduces the interference to other cells by taking into account queue backlogs and channel qualities for each user in the assignment of the downlink transmit power levels to each sub-carrier. This step prevents the network from wasting transmission power when there is insufficient data to send. Thus, it allows the base station 100 to make a more efficient use of its transmission power and also reduces the amount of interference power to neighboring sites.

Gradient-based scheduling is known to be an asymptotically optimal strategy for maximizing a concave utility function. The approach provides a convenient mechanism for constructing a dual graph theoretical resource allocation problem. The algorithm provides a mechanism by which each individual packets in each user's queue can be assigned a weight that may be proportional, for example, to its position in the queue or to its waiting time in the queue or to its priority in the queue. A utility-based weight can also be imposed based on the minimum amount of downlink transmit power that it takes to reliably send each packet over each sub-carrier. In the problem formulation, these weights are taken into consideration along with the utility-based metric of long-term average packet rates in order optimize the scheduling and transmit power assignment. Thus, the total utility for each user is actually a product of the individual utilities that are related to: packet throughput, downlink transmit power level and queue backlog.

The algorithm, in one embodiment, extends conventional optimization algorithms by considering an OFDMA network in which multiple users can send packets over the same sub-carrier during each frame (in non-overlapping time slots). In this formulation, the frame contains a variable number of packets from each user, which may be encoded at different data rates (the selection of which depends on the channel quality for each user).

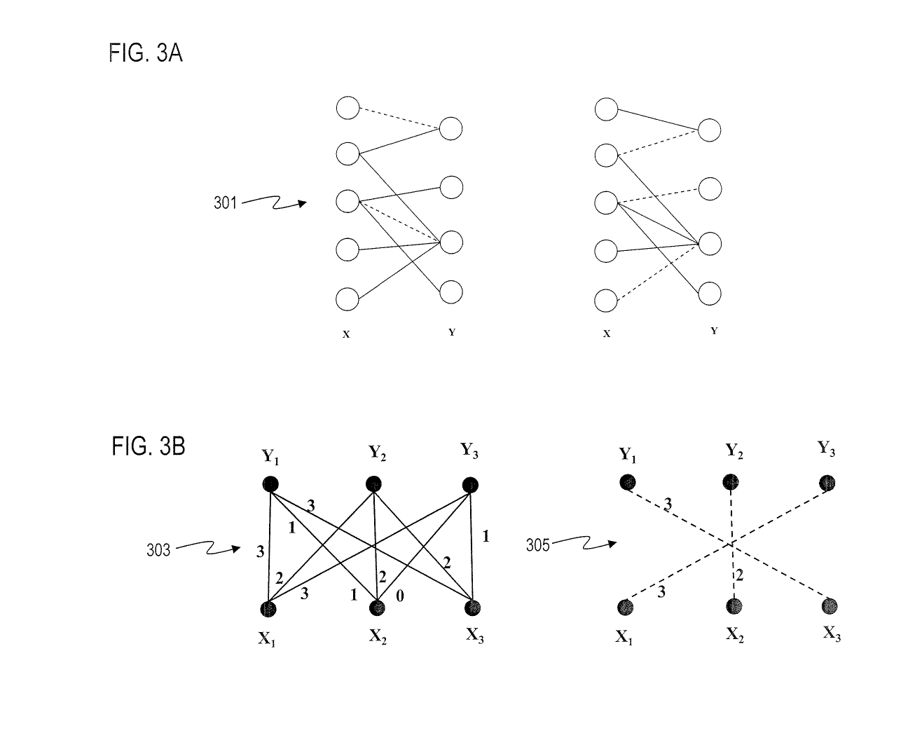

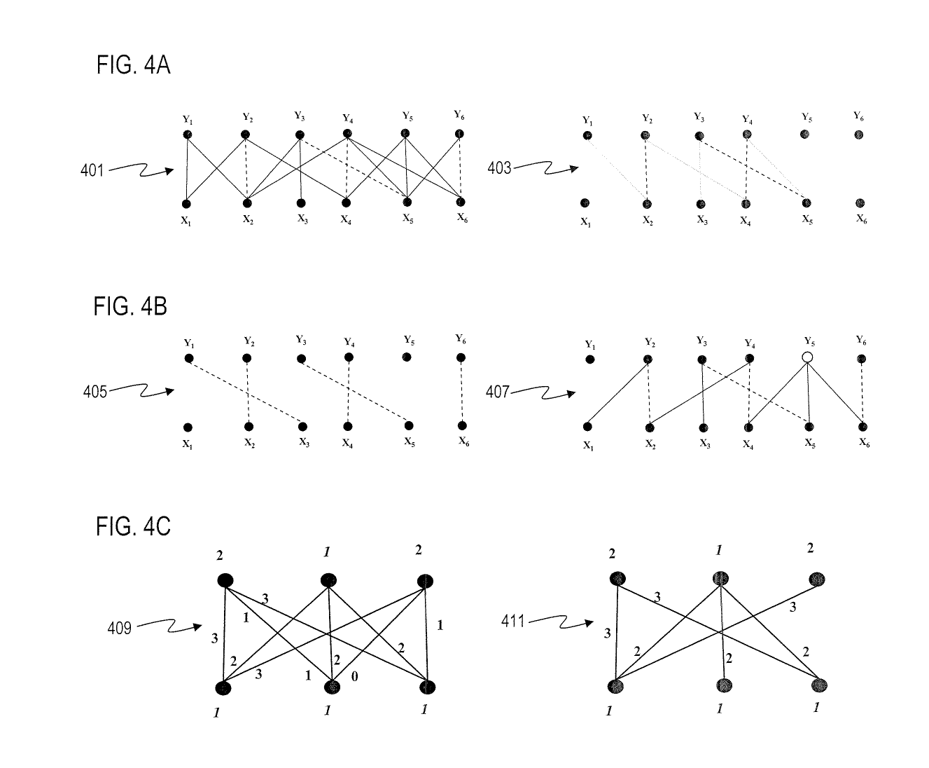

FIG. 3A is an example of a bipartite graph with two matchings, in accordance with an embodiment of the invention. By way of example, a graph 301, G=(V, E), includes a set of vertices, V, and the set of edges E that connect the vertices V, G is a bipartite graph if there exists a partition of the vertices, V=X∪Y, with no intersections of the nodes in each partition: X∩Y=Ø and with edges E⊂Y. This notation implies that a bipartite graph contains two distinctive node types, X and Y, with graph edges connecting only nodes from X to nodes from Y associated with each edge, e, in the graph is a weight, w(e). The solid lines represent connections, and the dashed lines indicate which of the edges is also a part of the matching (this notation holds true for FIGS. 3B and 4A-4C).

FIG. 3B is an example of a bipartite graph and associated maximum-weight matching, in accordance with an embodiment of the invention. A “matching” D, is a subset of edges in the undirected graph G such that no two edges have a common endpoint. Letting n=|V|, m=|E|, a “perfect matching” is a matching of cardinality |V|/2. The problems of finding a maximum matching and a perfect matching are two fundamental algorithmic graph problems. A graph 303 and its associated a maximum matching (a perfect matching in which the sum of the edge weights is maximum) graph 305 are shown in FIG. 3B. As shown, graph 303 represents a “complete” bipartite graph G=(V, E). A bipartite graph is “complete” if there exist edges between all nodes in X and all nodes in Y. In other words, every vertex of the first set is connected to every vertex of the second set. As mentioned, edges that are a part of the matching are represented by dashed-lines.

In a weighted bipartite graph, each edge has an associated value. The graph 303 includes weights of 3 for the following edges: (X₁, Y₁), (X₁, Y₃) and (X₃, Y₁), while edges (X₁, Y₂), (X₂, Y₂) and (X₃, Y₂) have weights of 2. Weighting of 1 is seen for edges (X₂, Y₁) and (X₃, Y₃). Without loss of generality, edges of weight 0 (e.g., edge (X₂, Y₃)) can be added to make a complete weighted graph. As seen in the maximum weighted bipartite matching graph 305, the sum of the values of the edges in the matching have a maximal value.

A “maximum weighted matching” is a matching D such that (1) each vertex that is included in the matching has one and only one edge in the matching (i.e., one vertex in X that is included in the matching cannot be matched to more than one vertex in Y), and (2) the sum of the edge weights in the matching D is a maximum over all such matchings. Given the sum of weights for the matching D,

$$w ( D ) = {\sum }_{e ∈ D} w ( e ) ,$$

a maximum weighted matching satisfies:

$${D}^{*} = {arg max}_{D} w ( D ) . \qquad ( 2 )$$

FIG. 4A is an illustration of matched/free vertices and alternating paths on a graph, in accordance with an embodiment of the invention. As evident from the above discussion, a vertex v is matched if it is an endpoint of an edge in D. In this example, the following vertices are matched: Y₂, Y₃, Y₄, Y₆; and X₂, X₄, X₅, X₆. All of the other vertices are “free.”

An illustration of matched/free vertices is provided in the graph 401, a “matching” D which includes the matched vertices (X₂,Y₂), (X₅,Y₃), (X₄,Y₄) and (X₆,Y₆)—is shown. The other vertices are free. Graph 403 shows alternating paths: Y₁, X₂, Y₂, X₄, Y₄, X₅, Y₃, and X₃.

FIG. 4B is an example of alternating trees on complete bipartite graph, in accordance with an embodiment of the invention. An alternating path is “augmenting” if both of its endpoints are free, as seen in graph 405. In graph 407, the augmenting path has one less edge in D than E-D. By replacing the D edges by the E-D edges, the size of the matching is incremented. An “alternating tree” is a tree that is rooted at some free vertex v in which every path is an alternating path; e.g., graph 301 of FIG. 3A.

FIG. 4C shows a feasible labeling l, and an equality graph Gₗ, in accordance with an embodiment of the invention. A vertex labeling is a function l: V→ [symbol] . That is, in an edge-weighted graph (e.g., graph 409), the vertex labeling maps each vertex to a real number. As seen in the FIG. 4C, a “feasible labeling,” l, is indicated in graph 409; and an equality graph Gₗ is represented at graph 411. A “feasible labeling” for a graph G is one that satisfies the following constraint:
l(x)+l(y)≧w(x,y), ∀xεX, yεY. (3)

The “equality graph” with respect to a labeling, l, is G=(V, Eₗ) where
Eₗ={(x,y): l(x)+l(y)=w(x,y)} (4)

If l is feasible and D is a perfect matching in Eₗ, then D is a max-weight matching. This is known as the Kuhn-Munkres (KM) theorem.

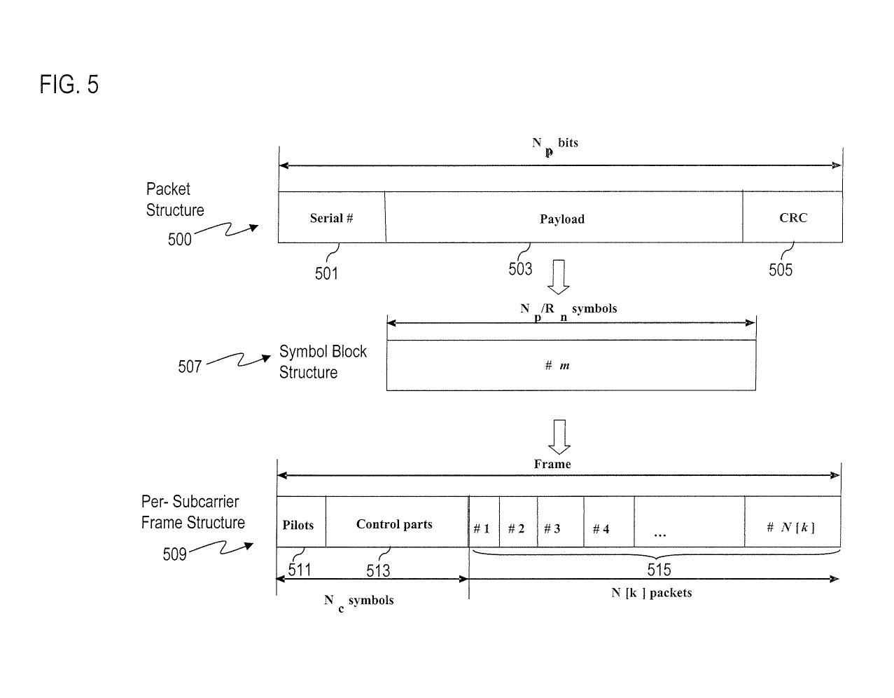

FIG. 5 is an example of packet structure, symbol-block structure and subcarrier frame structure, in accordance with an embodiment of the invention. In this example, a packet structure 500 includes a header field 501 (e.g., serial number), a payload 503, and a cyclic redundancy check (CRC) field 505. The length is Nₚ bits. The packet structure 500 is transported using a symbol block structure 507. For the purposes of explanation, the packet structure 500 is described with respect to transmission on the downlink.

The base station 100 has knowledge of the queue backlog and channel state conditions (e.g., per-sub-carrier) for each user, which allows the AMC (adaptive modulation coding) controller to select the appropriate modulation format and forward error correcting scheme on a frame-by-frame basis. According to one embodiment, a block fading channel model is assumed, where the channel state remains constant during a frame but varies between different frames. Essentially, the signal-to-noise ratio (SNR) experienced by user i at a particular sub-channel, k, dictates the selected modulation and encoding mode. Thus, at an encoding rate of R, bits per symbol, a packet is mapped to a symbol-block containing Nₚ/Rₙ symbols.

At the physical layer, the processing unit is a frame 509, which includes pilot(s) 511 and control parts 513. One or more data fields 515 are carried with the frame 509.

It is also assumed that the transmit power allocated to the kth sub-carrier during the nth downlink frame, p(n,k), is constrained such that 0≦P(n,k)≦Pₘₐₓ (k). Consequently, the total power, Pₜₒₜ (n) that may be used for downlink transmissions over the nth downlink frame is also bounded as follows:

$${P}_{tot} ( n ) = {\sum }_{k = 1}^{K} P ( n , k ) \\ 0 \leq {P}_{tot} ( n , k ) \leq {P}_{max} \\ {P}_{max} = {\sum }_{k = 1}^{K} {P}_{max} ( k ) \qquad ( 5 )$$

Under the above assumptions, the maximum number of packets per frame that sub-carrier k can reliably transmit to user i can be expressed as a function of the signal-to-noise ratio at that sub-carrier. For example, with adaptive Quadrature Amplitude Modulation (QAM), the number of packets that sub-carrier k can transmit for user i is given by:

$${c}_{i} [ k , n ] = \frac{{R}_{m}}{β {N}_{p}} max ( 0 , ⌊ 0.31 ( 10 {log}_{10} ( P ( n , k ) / {N}_{0 , i} ( n , k ) ) ) - 0.67 ⌋ ) packets \text{/} channel use \qquad ( 6 )$$

β is a constant related to a targeted bit-error-rate (BER) by the relation

$$β = \frac{1.5}{- ln ( 5 BER )} . \qquad ( 7 )$$

β indicates the difference between the SNR (Signal-to-Noise Ratio) needed to achieve a certain data transmission rate for a practical system and the theoretical limit, respectively, and is referred to as the SNR gap. N_{0,i} (n,k) denotes the interference and background noise that is measured by the ith user during the nth frame over the kth sub-carrier.

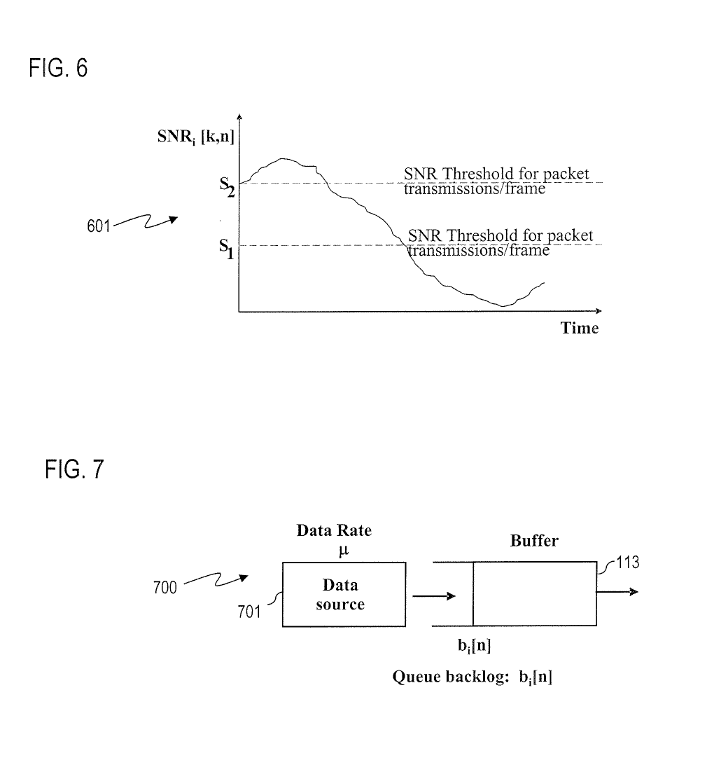

The AMC concept is further illustrated in FIG. 6.

FIG. 6 is an example of mapping of a user's signal-to-noise ratio packet capacity for the kth sub-carrier, in accordance with an embodiment of the invention. By way of example, two encoding modes are shown in graph 601: the first mode requires a certain SNR (Signal-to-Noise Ratio) (SNR>S₁) in order to reliably transmit one packet per frame, and the second mode 603 requires a higher SNR (SNR>S₁) to reliably transmit multiple packets (e.g., 2 packets) per frame.

FIG. 7 is an example of queuing system model, in accordance with an embodiment of the invention. According to certain embodiments, the following operating assumptions are made for a queuing system 700, involving a data source 701 that generates data at a rate, μ, into a buffer or queue (e.g., queue 113). First, the available frequency band is divided into K non-overlapping sub-carriers (or sub-channels). In an OFDMA system, the scheduling algorithm determines how to allocate the sub-channels during each frame, i.e., to whom and for what proportion of time, when the base station 100 needs to send data to multiple packets to best-effort users. During each frame, a sub-carrier can potentially be used to transmit multiple packets to different users. The number of packets per frame is a variable.

Also, it is assumed that the channel is frequency flat, and remains invariant during each frame, but can vary from frame to frame. This is a block fading channel model, which is applicable to slowly-varying (quasi-static) wireless channels. AMC is adjusted on a frame-by-frame basis. Furthermore, channel state information is available at the base station 100.

The packet arrival processes 700 to users' queue backlog during each frame are independent across frames. At the base station 100, the data link layer packets that are destined for a particular user are buffered into a queue 113 until they are serviced. In an exemplary embodiment, packets are not serviced within the same frame in which they arrive.

In the queuing system 700, bᵢ[n] denotes the instantaneous backlog of the ith user's queue at the beginning of the nth service time (frame). The queue evolution equation is given by bᵢ[n+1]=bᵢ[n]−min(bᵢ[n], Qᵢ[n])+aᵢ[n], where Qᵢ[n] denotes the number of packets that are removed from the queue 703 during the nth frame and aᵢ[n] represents the total number of arrivals during the nth frame.

The scheduler 107, which makes a sub-carrier assignment once during every frame based on each user's total channel quality and queue length, does not waste service rate. Hence, the scheduler 107 is constrained not to schedule more packets to be sent to a user than there are currently backlogged in the queue 113. This constraint appears in as the term min(bᵢ[n], Qᵢ[n]) in the queue evolution.

The amount of transmit power that is allocated to the kth sub-carrier is upper-bounded by a maximum proportion of the total downlink transmit power which is allocated to that sub-carrier. However, the network should not waste power. Hence, if the maximum proportion of power would actually service more packets than are currently available for transmission, then the base station 100 is constrained to reduce the level to the minimum value required in order to service the queue backlogs of all of the active users.

By way of example, utility-based optimization is considered based on the long-term average packet rate, i.e., the weighted average packet throughput over many epochs, rather than an instantaneous optimization. In general, an optimal long-term rate policy trades off between the desire to get maximum throughput and balance fairness during the current epoch and the desire to achieve the same in the future. The second goal is necessary for more fully exploiting multi-user diversity.

By exploiting an exponentially weighted low-pass time-window, the average long-term data rate for user i can be updated as follows:
r̅ᵢ̅[n]=(1−ρ_{w}) r̅ᵢ̅[n−1]+ρ_{w}rᵢ[n] (8)

where ρ_{w}>0 is a fixed (small) parameter and rᵢ[n] is the instantaneous packet rate. Therefore, the optimization problem should be expressed as maximizing the total utility with respect to average packet rates, that is

$${max}_{r [ n ] ∈ {C}_{π} ( H )} {\sum }_{i = 1}^{M} {U}_{1} ( {\overline{r}}_{i} [ n ] ) \qquad ( 9 )$$

where r[n] is the packet rate vector [r₁[n], r₂[n], . . . , r_{M}[n]] and C_{π}(H) is the instantaneous feasible data rate region at time n, which is determined by the current channel states, H:
H=[H₁[1], . . . , H₁[K], . . . , H_{M}[1], . . . , H_{M}[K]] (10)

and the allocation constraints of the dynamic sub-carrier allocation policy, π.

As indicated by equation (8), the long term average packet rate is also a function of the instantaneous packet rate. Hence the optimization problem in equation (9) can be equivalently expressed as

$$\begin{matrix}{max}_{{r}_{i} [ n ] ∈ {C}_{π} ( H )} {\sum }_{i = 1}^{M} V ( {r}_{i} [ n ] ) \\ where & ( 11 ) \\ \begin{matrix}V ( {r}_{i} [ n ] ) = U ( {\overline{r}}_{i} [ n ] ) \\ = U ( ( 1 - {ρ}_{w} ) {\overline{r}}_{i} [ n - 1 ] + {ρ}_{w} {r}_{i} [ n ] )\end{matrix} & ( 12 )\end{matrix}$$

This transformation of variables enables instantaneous optimization based on V(·) with respect to the “instantaneous” packet rates instead of U(·) with respect to the long-term average packet rates. The marginal utility function is given by

$$\begin{matrix}\frac{\partial V ( {r}_{i} [ n ] )}{\partial {r}_{i} [ n ]} = \frac{\partial U ( {\overline{r}}_{i} [ n ] )}{\partial {\overline{r}}_{i} [ n ]} \frac{\partial {\overline{r}}_{i} [ n ]}{\partial {r}_{i} [ n ]} \\ = {ρ}_{w} {U}^{′} ( {\overline{r}}_{i} [ n ] ) {\vert}_{{\overline{r}}_{i} [ n ] = ( 1 - {ρ}_{w} ) {\overline{r}}_{i} [ n - 1 ] + {ρ}_{w} {r}_{i} [ n ]} .\end{matrix} \qquad ( 13 )$$

If the weighting factor, ρ_{w} is small enough, then

$$\frac{\partial V ( {r}_{i} [ n ] )}{\partial {r}_{i} [ n ]} \approx {ρ}_{w} {U}^{′} ( {\overline{r}}_{i} [ n ] ) {\vert}_{{\overline{r}}_{i} [ n ] = {\overline{r}}_{i} [ n - 1 ]} . \qquad ( 14 )$$

From this approximation, it can be concluded that the current marginal utility values are totally determined by the previous resource allocation. Using a first-order Taylor formula to approximate the derivative in (14) and again assuming that ρ_{w} is small, it follows that

$$\begin{matrix} {U}_{1}^{′} ( {\overline{r}}_{i} [ n ] ) \approx \frac{{U}_{1} ( {\overline{r}}_{i} [ n ] ) - {U}_{1} ( {\overline{r}}_{i} [ n - 1 ] )}{{\overline{r}}_{i} [ n ] - {\overline{r}}_{i} [ n - 1 ]} \\ = \frac{{U}_{1} ( {\overline{r}}_{i} [ n ] ) - {U}_{1} ( {\overline{r}}_{i} [ n - 1 ] )}{{ρ}_{w} ( {r}_{i} [ n ] - {\overline{r}}_{i} [ n - 1 ] )}\end{matrix} \\ {\sum }_{i = 1}^{M} {U}_{1} ( {\overline{r}}_{i} [ n ] ) - {\sum }_{i = 1}^{M} {U}_{1} ( {\overline{r}}_{i} [ n - 1 ] ) \approx {\sum }_{i = 1}^{M} {U}_{1}^{′} ( {\overline{r}}_{i} ) {\vert}_{{\overline{r}}_{i} \approx {\overline{r}}_{i} [ n - 1 ]} ( {ρ}_{w} {r}_{i} [ n ] - {ρ}_{w} {\overline{r}}_{i} [ n - 1 ] ) . \qquad ( 15 )$$

Since all variables which are a function of the (n−1)-st frame are fixed at time n, and hence do not really affect the optimization, the optimization problem becomes one having a linear objective function as follows:

$${max}_{r [ n ] ∈ {C}_{π} ( H )} {\sum }_{i = 1}^{M} {U}_{i , 1}^{′} ( {\overline{r}}_{i} [ n - 1 ] ) {r}_{i} [ n ] . \qquad ( 16 )$$

Where the substitution, U₁ ( r̅ᵢ̅[n−1])=U_{i,1}( r̅ᵢ̅[n−1]), is made.

Although there are non-linear combinatorial optimization methods to solve equation (16), a different approach is taken by reformulating the utility-based rate optimization problem into a problem that can be solved using graph theory. In this equivalent problem formulation, each queue is represented as a “set” of nodes that require servicing and each sub-carrier is represented as a “set” of server nodes on a graph.

The number of packets that can be reliably sent to user i during the nth frame is simply the sum of the total number of packets that can be reliably sent over its assigned frequency set, Dᵢ, to which user i is assigned. Hence, given a frame duration of Tₛ, the following results

$${r}_{i} [ n ] {T}_{s} = {\sum }_{k = 1}^{K} {c}_{i} [ k , n ] {w}_{i} [ k , n ] Δ f \cdot {T}_{s} \qquad ( 17 )$$

with Δf being the sub-carrier spacing (in Hz) and wᵢ[k, n]ε{0, 1} being the indicator that sub-carrier k is one of the sub-carriers that has been allocated to user i. However, this optimization problem can be massaged so that there is more flexibility to facilitate assigning the same sub-carrier to different users during each frame. First, the number of packets that can be transmitted over the kth sub-carrier is considered—
pᵢ[k,n]=cᵢ[k,n]Δf·Tₛ. (18)

Under maximum power, the base station transmits the maximum number of packets to the ith user over the kth sub-channel. Hence, the number of packets is always upper-bounded by

$$\begin{matrix}{p}_{i} [ k , n ] \leq {c}_{i}^{*} [ k , n ] Δ f \cdot {T}_{s} \\ where & ( 19 ) \\ {c}_{i}^{*} [ k , n ] = \frac{{R}_{m}}{β {N}_{p}} max ( 0 , ⌊ 0.31 ( 10 {log}_{10} ( {P}_{max} ( k ) / {N}_{0 , i} ( n , k ) ) ) - 0.67 ⌋ ) packets \text{/} channel use & ( 20 )\end{matrix}$$

denotes the maximum number of packets that can be sent.

Letting Qᵢ[k,n] denote the actual number of packets that are serviced from the ith queue for downlink transmission over the kth sub-carrier during the nth frame, the following queuing service constraints apply:
1) The number of packets transmitted to user i over the kth sub-carrier cannot exceed the channel capacity for that user, i.e., Qᵢ[k,n]≦pᵢ*[k,n]=cᵢ*[k,n]Δf·Tₛ.
2) The scheduler does not waste service rate. This implies that the number of serviced packets cannot exceed the queue backlog, i.e.

$${\sum }_{k = 1}^{N} {Q}_{i} [ k , n ] \leq {b}_{i} [ n ] .$$

Under these two conditions, it follows that the maximum number of packets that can be serviced from queue i during the nth frame is
mᵢ[n]=min(maxₖ(pᵢ*[k,n]),bᵢ[n]) (21)

Thus, in the equivalent graph construction of this problem, each queue can be represented by a set of mᵢ[n] expanded “user nodes” on a graph.

In addition to the above two conditions, the following constraint takes the network (i.e., per sub-carrier) capacity into consideration: Letting N denote the maximum number of packets (of any length after AMC) that can be transmitted by a sub-carrier during the current frame then, Qᵢ[k, n]≦N.

Hence, each sub-carrier can be represented by a set of N expanded “server nodes” on a graph to represent the N available time slots per frame. Therefore, the optimization problem becomes

$$\begin{matrix}{max}_{r [ n ] ∈ {C}_{π} ( H )} {\sum }_{i = 1}^{M} {U}_{i}^{′} ( {\overline{r}}_{i} [ n - 1 ] ) {r}_{i} [ n ] {T}_{s} = {max}_{r [ n ] ∈ {C}_{π} ( H )} {\sum }_{i = 1}^{M} {U}_{i}^{′} ( {\overline{r}}_{i} [ n - 1 ] ) \underbrace{{\sum }_{k = 1}^{K} {p}_{i} [ k , n ] {w}_{i} [ k , n ]}_{{Q}_{i} [ n ] = {\sum }_{k = 1}^{K} {Q}_{i} [ k , n ]} \\ = {max}_{r [ n ] ∈ {C}_{π} ( H )} {\sum }_{i = 1}^{M} {U}_{i}^{′} ( {\overline{r}}_{i} [ n - 1 ] ) {\sum }_{k = 1}^{K} {\sum }_{m = 1}^{N} {\sum }_{r = 1}^{{m}_{i} [ k , n ]} {1}_{r \leq N} \cdot \\ {w}_{ir} [ k , m , n ] .\end{matrix} \\ s . t . \\ {Q}_{i} [ k , n ] \leq {p}_{i}^{*} [ k , n ] \\ {Q}_{i} [ n ] = {\sum }_{k = 1}^{K} {Q}_{i} [ k . n ] \leq {b}_{i} [ n ] \\ {Q}_{i} [ n ] \leq min ( {m}_{i} [ n ] , N ) \\ {m}_{i} [ k , n ] = min ( {p}_{i}^{*} [ k , n ] , {b}_{i} N ) \\ {m}_{i} [ n ] = min ( {max}_{k} ( {p}_{i}^{*} [ k , n ] ) , {b}_{i} [ n ] ) \qquad ( 22 )$$

With the new formulation of equation (22), several observations are pertinent:
1) The factor 1_{r≦N}·Wᵢᵣ[k, m, n] is a simple ON-OFF channel model which is either a 1 or a 0, depending on the channel state.
2) The sub-carrier allocation indicator, wᵢᵣ[k, m, n]ε{0, 1}. When Wᵢᵣ[k, m, n]=1, then the scheduler allows the ith queue to send its rth buffered packet over sub-carrier k. Furthermore, this is the mth such packet selected to be sent over sub-channel k during the frame (in a concatenated frame consisting of packets from multiple users). Otherwise, when wᵢᵣ[k, m, n]=0, this particular time slot used with the k-th sub-carrier is not allocated to service queue i during the current servicing epoch.

Although the problem construction in (22) takes many important aspects of the channel state and the queue model into consideration, there is no real mechanism in place to help “balance” the queues 113 to ensure a more equitable queue distribution length after servicing nor is there a way to take waiting time into account. In the former case, when queue occupancy is the primary concern, a non-negative factor can be introduced into the optimization which effectively weights the connectivities between the rth expanded queue node (r=1, . . . , mᵢ[n]) and all of the expanded sub-carrier nodes to which it is connected (i.e. for which it can at least send one packet reliably) by a factor that is proportional to the number of packets waiting behind it in the queue.

In the latter case, when packet waiting time is the primary concern, a non-negative quantity can be introduced which weights the connectivities between the rth expanded queue node (r=1, . . . , mᵢ[n]) and all of the expanded sub-carrier nodes to which it is connected (i.e., for which it can at least send one packet reliably by a factor that is proportional to the time that the packet has spent waiting in the queue 113.

Therefore, when the utility-based optimization which takes both channel state and queue occupancy into account, the objective function becomes

$${max}_{r [ n ] ∈ {C}_{π} ( H )} {\sum }_{i = 1}^{M} {U}_{i}^{′} ( {\overline{r}}_{i} [ n - 1 ] ) {\sum }_{k = 1}^{K} {\sum }_{m = 1}^{N} {\sum }_{r = 1}^{{m}_{i} [ k , n ]} ( {b}_{i} [ n ] - r + 1 ) \cdot \\ {1}_{r \leq N} \cdot {w}_{ir} [ k , m , n ] . \qquad ( 23 )$$

Conversely, when the objective involves both channel state and waiting time, the objective function can be written as

$${max}_{r [ n ] ∈ {C}_{π} ( H )} {\sum }_{i = 1}^{M} {U}_{i}^{′} ( {\overline{r}}_{i} [ n - 1 ] ) {\sum }_{k = 1}^{K} {\sum }_{m = 1}^{N} {\sum }_{r = 1}^{{m}_{i} [ k , n ]} {W}_{ir} [ n ] \cdot {1}_{r \leq N} \cdot {w}_{ir} [ k , m , n ] . \qquad ( 24 )$$

with Wᵢᵣ[n] being the time that the rth buffered packet has spent in the queue. It is noted that this is a novel reconstruction of the cross-layer utility optimization problem that combines a utility-based weight with a queue state-related weight in order to better address the key issues of fairness and efficiency. According to the construction of (23) and (24), it may be assumed that the transmission power level has been pre-determined (or set to the maximum level) in order to determine the per-subcarrier capacity for the upcoming transmission frame.

Alternately, the power efficiency of the downlink transmission is taken into consideration by constructing a utility function that measures the network's satisfaction with the amount of downlink power that is necessary to reliably transmit each packet over each individual sub-carrier. Letting Pᵢ¹[n, k] represent the minimum amount of power that is necessary to send one packet over the kth sub-carrier to the ith user during the nth frame and let U_{i,2} (·) be a convex utility function that measures the network's satisfaction with a certain transmit power level, then, the utility function is defined as:
U_{i,2}(P¹[n,k]) (25)

This quantity measures the network's satisfaction with having to expend a certain amount of power to transmit. Hence, the final optimization also weights each packet with this transmission-power based utility function.

$${max}_{r [ n ] ∈ {C}_{π} ( H )} {\sum }_{i = 1}^{M} {U}_{i}^{′} ( {\overline{r}}_{i} [ n - 1 ] ) {\sum }_{k = 1}^{K} {\sum }_{m = 1}^{N} {\sum }_{r = 1}^{{m}_{i} [ k , n ]} ( {b}_{i} [ n ] - r + 1 ) \cdot {U}_{i , 2} ( {P}_{i}^{1} [ n , k ] ) \cdot {1}_{r \leq N} \cdot {w}_{ir} [ k , m , n ] \\ or \\ {max}_{r [ n ] ∈ {C}_{π} ( H )} {\sum }_{i = 1}^{M} {U}_{i}^{′} ( {\overline{r}}_{i} [ n - 1 ] ) {\sum }_{k = 1}^{K} {\sum }_{m = 1}^{N} {\sum }_{r = 1}^{{m}_{i} [ k , n ]} {W}_{ir} [ n ] \cdot {U}_{i , 2} ( {P}_{i}^{1} [ n , k ] ) \cdot \\ {1}_{r \leq N} \cdot {w}_{ir} [ k , m , n ] \qquad ( 26 )$$

This optimization problem may be solved by finding the equivalent bipartite graph construction for this problem.

An equivalent bipartite construction can be achieved as follows. First, associated with each queue i, mᵢ[n] expanded nodes, labeled as aᵢ₁, aᵢ₂, . . . aᵢₘ_{ᵢ}[n]·, as constructed. The number of expanded nodes, mᵢ[n], cannot exceed the maximum packet capacity, pᵢ*[k,n], or the queue backlog, whichever is less. The maximum packet capacity is determined as the number of packets that can be reliably sent to user i over sub-carrier k during the nth frame when the maximum proportion of power, Pₘₐₓ (k), is allocated to the kth sub-carrier.

U={a₁₁, a₁₂, . . . , a₁ₘ_{₁}_{[n]}, . . . , a_{M1}, a_{M2}, . . . , a_{Mm}_{_{M}}_{[n]}} represents the set of all such nodes, and V={v₁₁, v₁₂, . . . , v_{1N}, . . . , v_{K1}, v_{K2}, . . . , v_{KN}} is the set of servers associated with the expanded sub-carrier model. It is noted that the nth expanded node associated with sub-carrier k services the packet that will occupy the nth position in its frame of concatenated packets.

If |U|≠|V|, then one can add virtual extended nodes to the set of smaller cardinality until |U|=|V|. Letting E={(aᵢₘ,vₖᵣ)} represent the set of edges representing connectivities, these connectivities indicate whether the channel can be used to reliably send at least one packet during the nth frame.

Letting ψ: E [symbol] [symbol] , ψ(aᵢₘ, vₖᵣ)=eᵢₘ[n]·Uᵢ′( r̅ᵢ̅[n−1])·U_{i,2}(Pᵢ¹[n, k]) be the weight of each edge in E, the queue-dependent weight, eᵢₘ[n], is defined according to the desired criterion. In this example, queue-dependent edge weights that take queue backlog or waiting time into account have been considered: eᵢₘ[n]=bᵢ[n]−m+1 or eᵢₘ[n]=Wᵢₘ[n] However, this method is not restricted to those particular weightings.

It is noted that if Pₘₐₓ (k) results in a channel packet capacity that exceeds the queue back logs of all of the active users that are connected to sub-carrier k, that the network can decrease the transmit power level to the minimum required in order to reliably send all of the packets in the queues. This results in a power saving at the base station 100 and less interference to other cells (in the case of a cellular network).

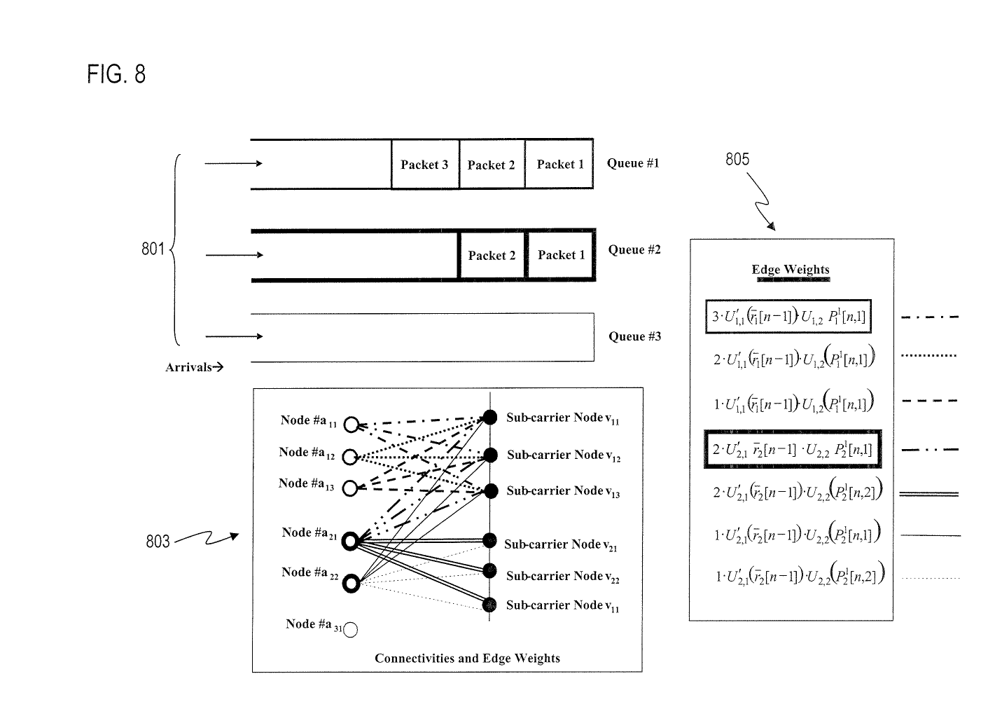

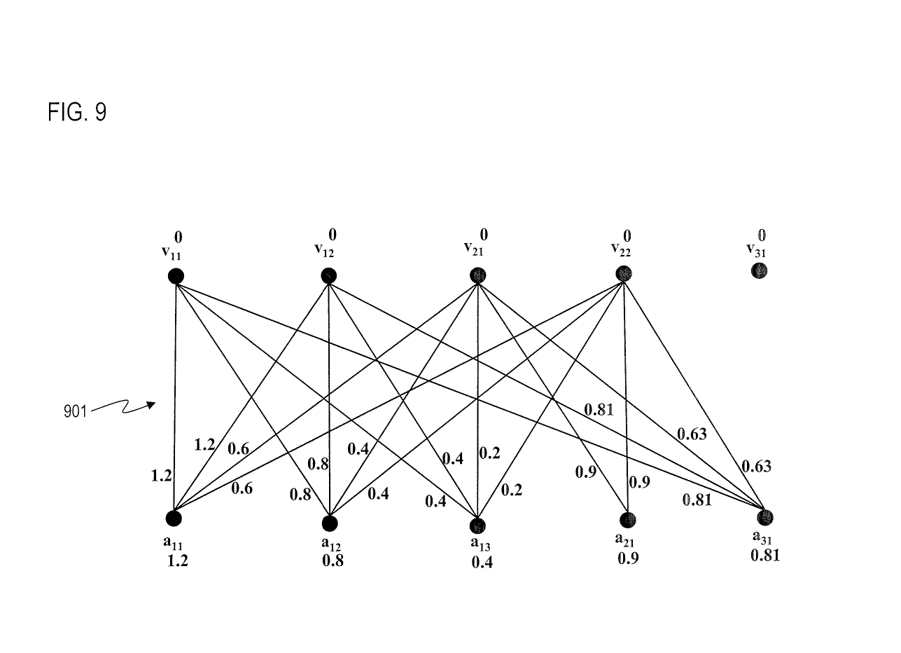

FIG. 8 is an example of an equivalent bipartite graph construction for optimal cross-layer resource allocation, in accordance with an embodiment of the invention. For the purposes of explanation, a simple example of how to construct the bipartite graph is described an OFDMA system that has three users and two sub-carriers. A maximum of three packets can be sent for transmission over each sub-carrier during each frame. Queues 801 are provided for the users; i.e., user 1 is assigned Queue #1, user 2 to Queue #2, and user 3 to Queue #3. Queue #1 has a queue backlog of 3 packets, while Queue #2 has a backlog of 2 packets. The queue associated with User 3 (Queue #3) is empty (0 packets). Based on the allocation during the previous (n−1)^{st} frame, the gradient utilities of the long term average packet throughput for each user are given by U₁′(r₁[n−1], U₁′(r₂[n−1]) and U₁′(r₃[n−1]).

Furthermore, the amount of power that it takes to send one packet to user i (i=1, . . . , 3) over the kth sub-carrier (k=1, 2) is P₁¹[n,k]. Since User 3 (Queue #3) does not have any packets to send, Queue #3 does not have connectivity to either sub-carrier (edge weights are zero). Graph 803 shows connectivities and edge weights for this example. It is noted that User 1 (Queue #1) does not have connectivity to sub-carrier 2. This implies that, due to channel quality, that the maximum transmit power level that can be used over the 2^{nd} sub-carrier (Pₘₐₓ (2)) is insufficient for the base station 100 to send User 2 at least one packet (again, edge weights are zero).

The corresponding edge weights 805 are shown. In this exemplary scenario, the queue backlog as the queue-dependent weight is used, although also it is contemplated that packet waiting time or another suitably defined quantity can be used.

The “maximum weight matching” on the equivalent bipartite graph is determined, wherein the scheduler 107 is required to allocate the sub-carriers (or, equivalently, assign a one or zero to wᵢᵣ[k, m, n]) in order to maximize the weight of the assigned edges in the graph. It is noted that maximum weight matching on a bipartite graph allows only one assignment per edge, which implies that each expanded sub-carrier node can only service one packet. This constraint prevents packets from being sent simultaneously (in time) over the same sub-carrier. However, by expanding each sub-carrier into a number of expanded server nodes, the packets from different users can be time-multiplexed and sent over a single sub-carrier during a single downlink frame.

According to one embodiment, the maximum weight matching problem can be solved using the Hungarian method or another suitably defined algorithm. For illustrative purposes, the use of the Hungarian method to solve this problem is explained.

This approach involves generating an initial labeling l and matching D in Eₗ. If D is perfect, then the process ends. Otherwise, a free vertex, a ε X, is selected, and the following is set: S={a}, T=Ø.

If Nₗ(S)=T, then the process update the labels (forcing Nₗ(S)≠T) using the following set of equations:

$${α}_{l} = {min}_{a ∈ S , v ∉ T} \{ l ( a ) + l ( v ) - w ( a , v ) \} \\ \begin{matrix}l ( a ) ↦ l ( a ) - {α}_{l} & if v ∈ S \\ l ( v ) ↦ l ( v ) + {α}_{l} & if v ∈ T \\ 1 ( a ) = 1 ( a ) , l ( v ) = l ( v ) & otherwise\end{matrix} \qquad ( 27 )$$

If Nₗ(S)≠T, then select v ε Nₗ(S)−T. If v is free, then a−v is an augmenting path. The process augments D and the vertex selecting step is revisited. If v is matched (assuming a certain z), the “alternating tree” is extended as follows: S=S∪{z}, T=T∪{v}. Next, the steps associated with determining whether Nₗ(S)=T are repeated.

The above process is then applied in order to determine the optimal sub-carrier assignment and transmit power level, given the queue backlogs or packet waiting times in the queue.

An exemplary application is now explained.

FIG. 9 shows an initial graph with a feasible initial labeling, in accordance with an embodiment of the invention. An example is considered in which there are a total of two OFDMA sub-carriers. The maximum number of packets (of any length) that may be transmitted during each downlink frame is N=2. There are three active users. The user's queues have backlogs of 3, 4 and 1 packets, respectively: i.e., bₗ[n]=3,b₂[n]=4, b₁[n]=1. Based on the packet rate assignment during the previous frame, the user's utilities of their average packet rate are, respectively, given by U_{1,1}′=0.5, U_{2,1}′=0.75, U_{3,1}′=0.9.

Initially, the maximum allowed power for the downlink transmission at each sub-carrier is selected. Under this power allocation, User 1 can send three packets and is connected to (i.e. can transmit over) sub-carriers #1 and 2, User 2 can send one packet over sub-carrier 2 but cannot transmit any packets over sub-carrier 1 (due to channel quality) and User 3 can send one packet over either sub-carrier 1 or sub-carrier 2. The network's utility of the power level that it takes to reliably send each individual packet over the sub-carriers is given by: U_{1,2}(P₁¹[n,1])=0.8, U_{1,2}(P₁¹[n,2])=0.4, U_{2,2}(P₂¹[n,2])=0.3, U_{3,2}(P₃¹[n,1])=0.9, U_{3,2}(P₃¹[n,2])=0.7.

Hence, the weight of the edge of each extended user node, aim, to each extended sub-carrier node, k, is the product Uᵢ′( r̅ᵢ̅[n−1])·Uₐ_{ᵢₘ}_{,2}(Pᵢ¹[n,k])·(bᵢ[n]−m+1). The initial graph is shown in FIG. 9. Since there are five total packets 901 and only four extended sub-carrier nodes 903, the graph is extended by adding a “virtual” sub-carrier node: V₃₁ 905 so that the graph has the same number of extended sub-carrier nodes and user-nodes.

The initial labeling in graph 901 is as follows:

$${U}_{1 , 1}^{′} ( {\overline{r}}_{1} [ n - 1 ] ) = 0.5 ; {U}_{2 , 1}^{′} ( {\overline{r}}_{2} [ n - 1 ] ) = 0.75 ; {U}_{3 , 1}^{′} ( {\overline{r}}_{3} [ n - 1 ] ) = 0.9$$

$${U}_{1 , 2} ( {P}_{1}^{1} [ n , 1 ] ) = 0.8 ; {U}_{1 , 2} ( {P}_{1}^{1} [ n , 2 ] ) = 0.4$$

$${U}_{2 , 2} ( {P}_{2}^{1} [ n , 2 ] ) = 0.3$$

$${U}_{3 , 2} ( {P}_{3}^{1} [ n , 1 ] ) = 0.9 ; {U}_{3 , 2} ( {P}_{3}^{1} [ n , 2 ] ) = 0.7$$

$${b}_{1} [ n ] = 3$$

$${b}_{2} [ n ] = 4$$

$${b}_{3} [ n ] = 1$$

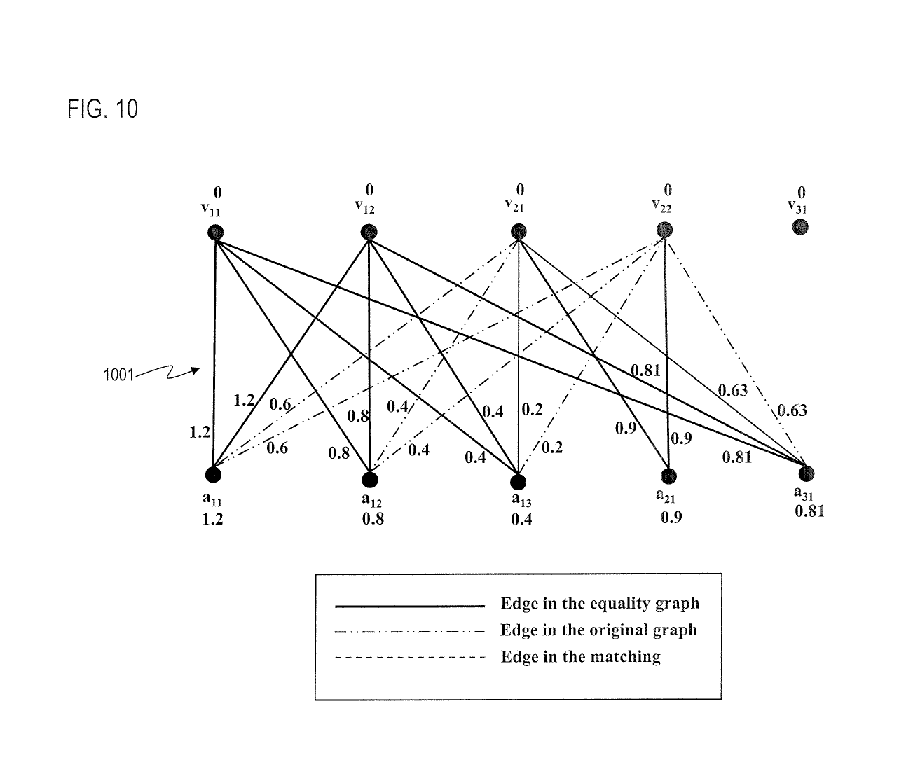

The associated equality graph is shown in FIG. 10. (It is noted that the solid lines are edges in the equality graph. The dotted lines are only shown for reference to the original graph).

The equality edges, El are indicated as solid lines. It is noted that the dotted lines are not edges in the equality graph, but are shown here for illustrative purposes. The number of packets that can be sent over each sub-carrier is determined by assuming that the network uses Pmax(k) over the kth sub-carrier. If Pmax(k) is more than is required in order to service all of the packets that are candidates for transmission over sub-carrier k, then it is reduced to the minimum value that is necessary to service all of the candidate packets.

Edge weights and labels in graph 1001 are shown as follows:

$$e ( {a}_{11} , {v}_{11} ) = 1.2 ; e ( {a}_{11} , {v}_{12} ) = 1.2 ; e ( {a}_{11} , {v}_{21} ) = 0.6 ;$$

$$e ( {a}_{11} , {v}_{22} ) = 0.6 ; e ( {a}_{11} , {v}_{31} ) = 0 ;$$

$$e ( {a}_{12} , {v}_{11} ) = 0.8 ; e ( {a}_{12} , {v}_{12} ) = 0.8 ; e ( {a}_{12} , {v}_{21} ) = 0.4 ;$$

$$e ( {a}_{12} , {v}_{22} ) = 0.4 ; e ( {a}_{11} , {v}_{31} ) = 0 ;$$

$$e ( {a}_{13} , {v}_{11} ) = 0.4 ; e ( {a}_{13} , {v}_{12} ) = 0.4 ; e ( {a}_{13} , {v}_{21} ) = 0.2 ;$$

$$e ( {a}_{13} , {v}_{22} ) = 0.2 ; e ( {a}_{13} , {v}_{31} ) = 0 ;$$

$$e ( {a}_{21} , {v}_{11} ) = 0.0 ; e ( {a}_{21} , {v}_{12} ) = 0.0 ; e ( {a}_{21} , {v}_{21} ) = 0.9 ;$$

$$e ( {a}_{21} , {v}_{22} ) = 0.9 ; e ( {a}_{21} , {v}_{31} ) = 0 ;$$

$$e ( {a}_{31} , {v}_{11} ) = 0.81 ; e ( {a}_{31} , {v}_{12} ) = 0.81 ; e ( {a}_{31} , {v}_{21} ) = 0.63 ;$$

$$e ( {a}_{31} , {v}_{22} ) = 0.63 ; e ( {a}_{31} , {v}_{31} ) = 0 ;$$

### Edge Weights

$$l ( {a}_{11} ) = 1.2 ; l ( {a}_{12} ) = 0.8 ; l ( {a}_{13} ) = 0.4 ; l ( {a}_{21} ) = 0.9 ; l ( {a}_{31} ) = 0.81 ;$$

$$l ( {v}_{11} ) = 0 ; l ( {v}_{12} ) = 0 ; l ( {v}_{21} ) = 0 ; l ( {v}_{22} ) = 0 ; l ( {v}_{31} ) = 0 ;$$

### Edge Labels

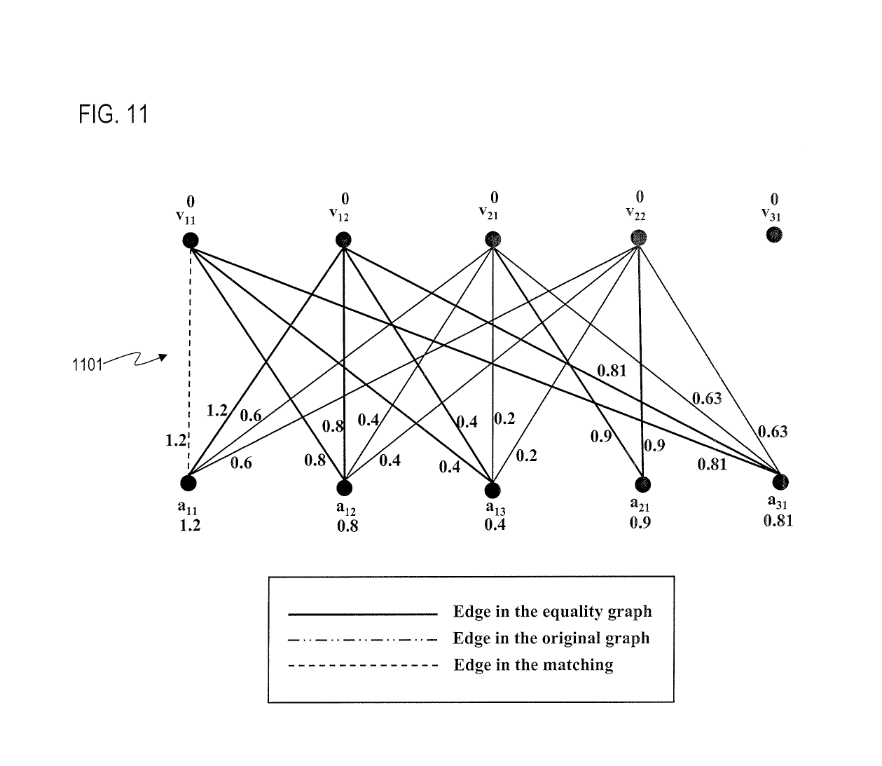

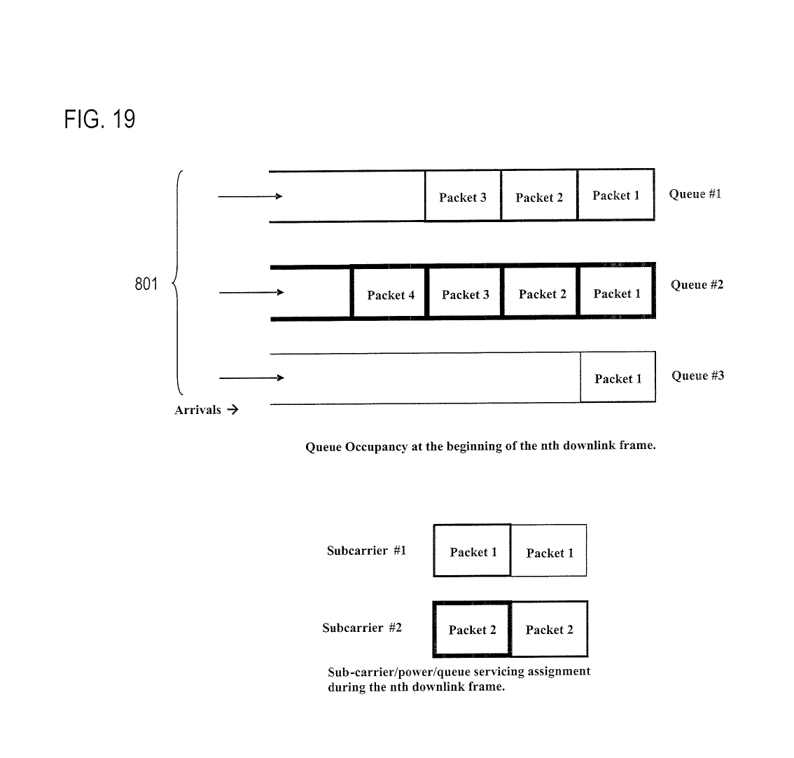

The algorithmic steps are shown in FIGS. 10-18 and the final solution is shown in FIG. 19. FIG. 11 shows an initial matching and calculation to compute the alternating path in the graph 1101, which is constructed from the elements of S and T:

$$Initial Matching \text{:} O / . \\ M is not perfect . \\ Pick a free vertex S = \{ {a}_{11} \} . \\ T = O / . \\ {N}_{l} ( S ) = \{ {v}_{11} , {v}_{12} \} \neq T . \\ Pick y ∈ {N}_{l} ( S ) \backslash T = {v}_{11} . \\ T = T ⋃ y = {v}_{11} . \\ {v}_{11} is not matched . \\ M \text{:} ( {a}_{11} , {v}_{11} ) .$$

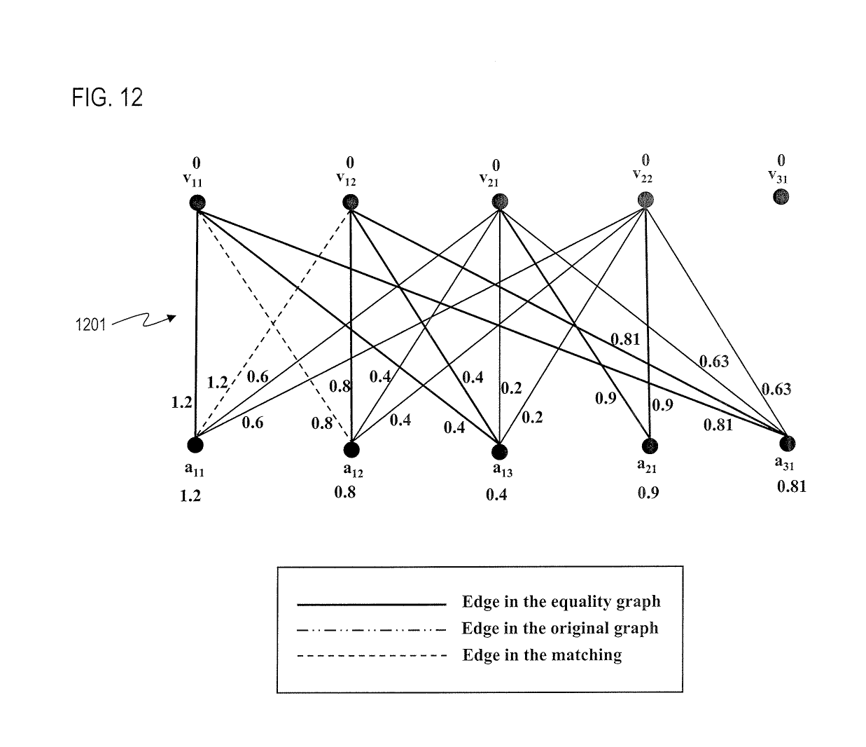

FIG. 12 shows continued calculations of the alternating tree in the graph 1201:

$$Matching M \text{:} ( {a}_{11} , {v}_{11} ) . \\ M is not perfect . \\ Pick a free vertex in {}_{}^{``}{a}{}_{}^{″} \text{:} S = \{ {a}_{12} \} . \\ T = O / . \\ {N}_{l} ( S ) = \{ {v}_{11} , {v}_{12} \} . \\ {N}_{l} ( S ) \neq T . \\ Pick a y ∈ {N}_{l} ( S ) \backslash T = \{ {v}_{11} , {v}_{12} \} . \\ y = {v}_{11} . \\ y is matched to {a}_{11} son S = \{ {a}_{12} , {a}_{11} \} T = Y ⋃ y = {v}_{11} . \\ {N}_{l} ( S ) = \{ {v}_{11} , {v}_{12} \} . \\ {N}_{l} ( S ) \neq T . \\ y ∈ {N}_{l} ( S ) \backslash T = {v}_{12} . \\ {v}_{12} is not matched so T = T ⋃ y = \{ {v}_{11} , {v}_{12} \} . \\ M \text{:} ( {a}_{12} , {v}_{11} ) , ( {a}_{11} , {v}_{12} ) .$$

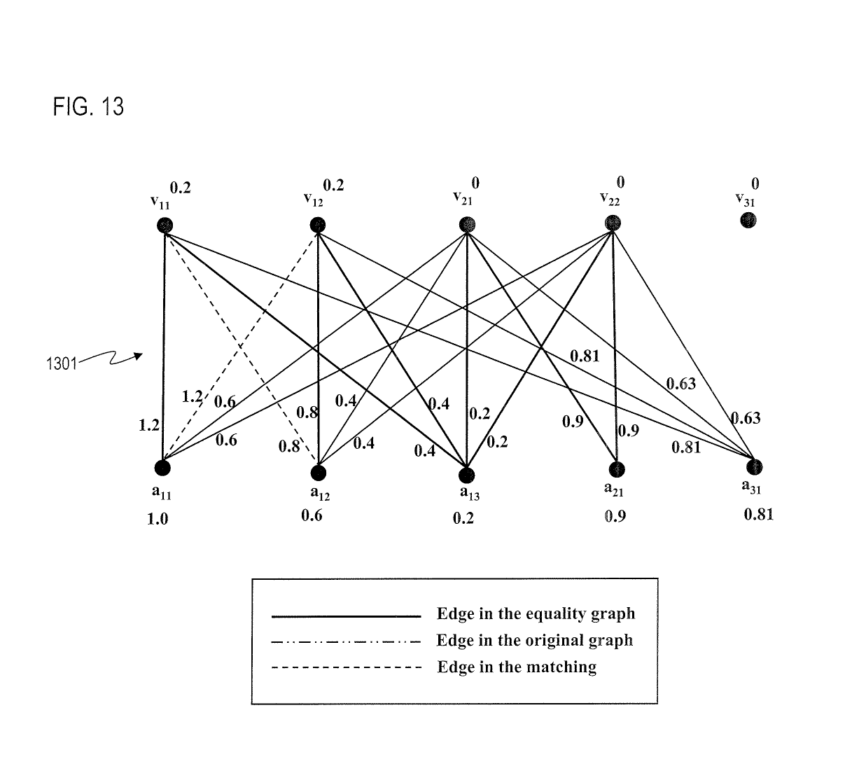

FIG. 13 shows an updated graph 1301 in which new labels and new quality graph are generated.

$$M \text{:} ( {a}_{12} , {v}_{11} ) , ( {a}_{11} , {v}_{12} ) . \\ M is not perfect . \\ Pick a free vertex \text{:} S = \{ {a}_{13} \} . \\ T = O / . \\ {N}_{l} ( S ) = \{ {v}_{11} , {v}_{12} \} . \\ {N}_{l} ( S ) \neq T . \\ Pick a y ∈ {N}_{l} ( S ) \backslash T = \{ {v}_{11} , {v}_{12} \}$$

$$y = {v}_{11} . \\ {v}_{11} is matched to {a}_{12} so S = S ⋃ {a}_{12} = \{ {a}_{13} , {a}_{12} \}$$

$$and T = T ⋃ y = \{ {v}_{11} , {v}_{12} \} . \\ {N}_{l} ( S ) = T . \\ Generate new labels and create new equality graph .$$

$${α}_{1} = l ( {a}_{13} ) + l ( {v}_{21} ) - e ( {a}_{13} , {v}_{21} ) = 0.2$$

$${α}_{2} = l ( {a}_{13} ) + l ( {v}_{22} ) - e ( {a}_{13} , {v}_{21} ) = 0.2$$

$${α}_{3} = l ( {a}_{13} ) + l ( {v}_{31} ) - e ( {a}_{13} , {v}_{31} ) = 0.4$$

$${α}_{4} = l ( {a}_{12} ) + l ( {v}_{21} ) - e ( {a}_{12} , {v}_{21} ) = 0.4$$

$${α}_{5} = l ( {a}_{12} ) + l ( {v}_{22} ) - e ( {a}_{12} , {v}_{21} ) = 0.4$$

$${α}_{6} = l ( {a}_{12} ) + l ( {v}_{31} ) - e ( {a}_{12} , {v}_{31} ) = 0.8$$

$${α}_{7} = l ( {a}_{11} ) + l ( {v}_{21} ) - e ( {a}_{11} , {v}_{21} ) = 0.6$$

$${α}_{8} = l ( {a}_{11} ) + l ( {v}_{22} ) - e ( {a}_{11} , {v}_{22} ) = 0.6$$

$${α}_{9} = l ( {a}_{11} ) + l ( {v}_{31} ) - e ( {a}_{11} , {v}_{31} ) = 1.2$$

$${α}_{l} = min \{ {α}_{1} , … . {α}_{9} \} = 0.2$$

$$l ( {a}_{13} ) = 0.2 ; l ( {a}_{12} ) = 0.6 ; l ( {a}_{11} ) = 1.0 ;$$

$$l ( {v}_{11} ) = 0.2 ; l ( {v}_{12} ) = 0.2$$

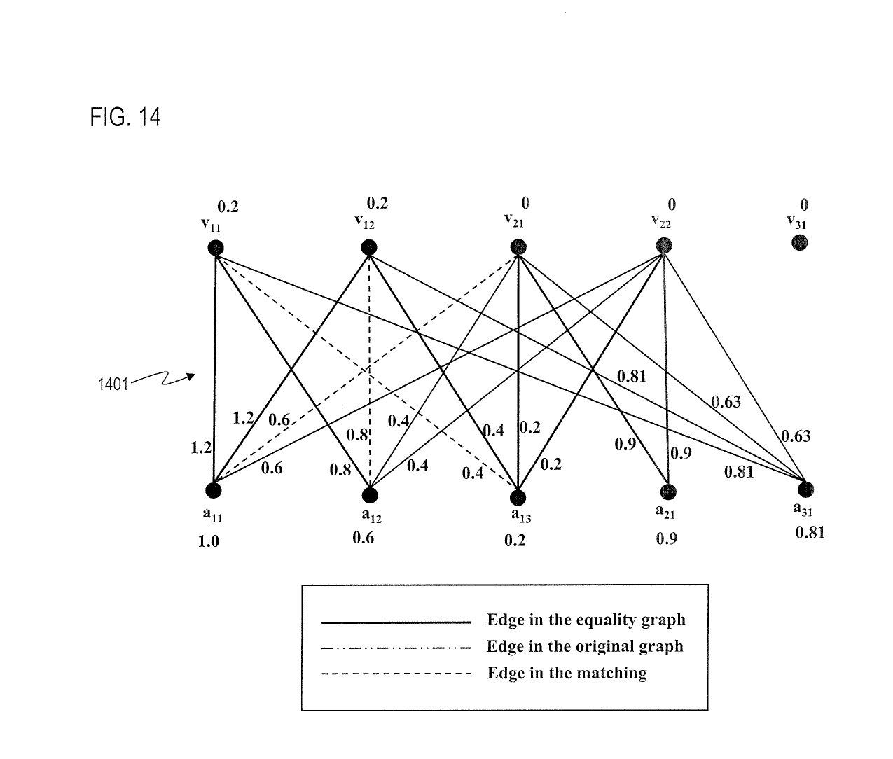

FIG. 14 shows a continued calculations of the alternating tree in the graph 1401:

$$M \text{:} ( {a}_{12} , {v}_{11} ) . ( {a}_{11} , {v}_{12} ) . \\ S = S ⋃ {a}_{11} = \{ {a}_{13} , {a}_{12} , {a}_{11} \} and T = T ⋃ y = \{ {v}_{11} , {v}_{12} \} . \\ {N}_{l} ( S ) = \{ {v}_{11} . {v}_{12} , {v}_{21} , {v}_{22} \} \neq T . \\ Pick a y ∈ {N}_{l} ( S ) \backslash T = \{ {v}_{21} , {v}_{22} \} . \\ y = {v}_{21} . \\ {v}_{21} is not matched so T = T ⋃ y = \{ {v}_{11} , {v}_{12} , {v}_{21} \} . \\ M \text{:} ( {a}_{13} , {v}_{11} ) , ( {a}_{12} , {v}_{12} ) , ( {a}_{11} , {v}_{21} ) .$$

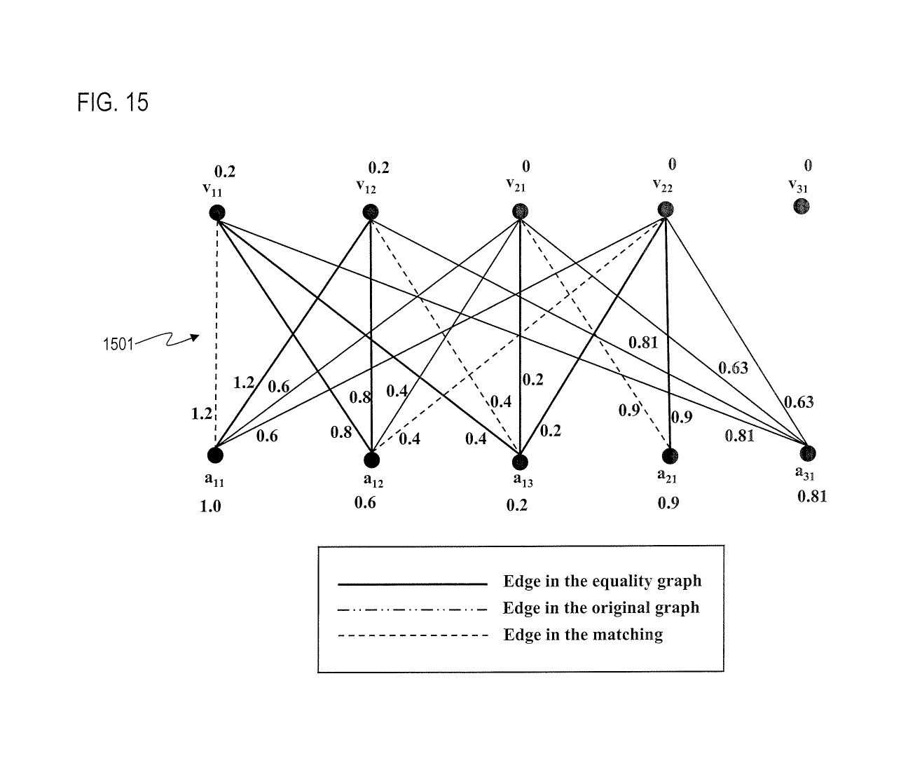

FIG. 15 shows a continued calculation of the alternating tree in the graph 1501:

$$M \text{:} ( {a}_{13} , {v}_{11} ) , ( {a}_{12} , {v}_{12} ) , ( {a}_{11} , {v}_{21} ) . \\ M is not perfect . \\ Pick a free vertex \text{:} S = \{ {a}_{21} \} . \\ T = O / . \\ {N}_{l} ( S ) = \{ {v}_{21} , {v}_{22} \} . \\ y ∈ {N}_{l} ( S ) \backslash T = \{ {v}_{21} , {v}_{22} \} . \\ y = {v}_{21} . \\ {v}_{21} is matched to {a}_{11} so S = S ⋃ {a}_{11} = \{ {a}_{21} , {a}_{11} \}$$

$$and T = T ⋃ y = {v}_{21} . \\ {N}_{l} ( S ) = \{ {v}_{11} , {v}_{12} , {v}_{21} , {v}_{22} \} \neq T . \\ Pick y ∈ {N}_{l} ( S ) \backslash T = \{ {v}_{11} , {v}_{12} , {v}_{22} \} . \\ y = {v}_{11} . \\ {v}_{11} is matched to {a}_{13} so …$$

$$S = S ⋃ {a}_{13} = \{ {a}_{21} , {a}_{11} , {a}_{13} \} and T = T ⋃ {v}_{11} = \{ {v}_{21} , {v}_{11} \} . \\ {N}_{l} ( S ) = \{ {v}_{11} , {v}_{12} , {v}_{21} , {v}_{22} \} \neq T . \\ Pick y ∈ {N}_{l} ( S ) \backslash T = \{ {v}_{12} , {v}_{22} \} . \\ y = {v}_{12} . \\ {v}_{12} is matched to {a}_{12} so …$$

$$S = S ⋃ {a}_{12} = \{ {a}_{21} , {a}_{11} , {a}_{13} , {a}_{12} \}$$

$$and T = T ⋃ {v}_{12} = \{ {v}_{21} , {v}_{11} , {v}_{12} \} . \\ {N}_{l} ( S ) = \{ {v}_{11} , {v}_{12} , {v}_{21} , {v}_{22} \} \neq T . \\ Pick y ∈ {N}_{l} ( S ) \backslash T = \{ {v}_{22} \} . \\ {v}_{22} is not matched so$$

$$T = T ⋃ y = \{ {v}_{21} , {v}_{11} , {v}_{12} , {v}_{22} \} . \\ M \text{:} ( {a}_{21} , {v}_{21} ) , ( {a}_{11} , {v}_{11} ) , ( {a}_{13} , {v}_{12} ) , ( {a}_{12} , {v}_{22} ) .$$

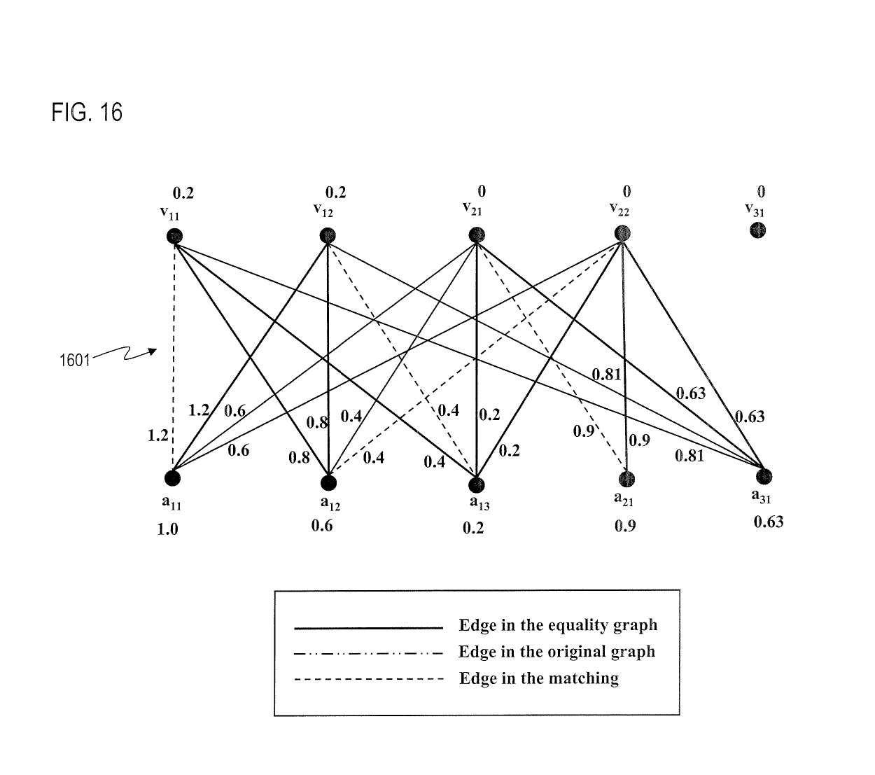

FIG. 16 shows a graph in which new labels are generated and new equality graph 1601 is calculated.

$$M \text{:} ( {a}_{21} , {v}_{21} ) , ( {a}_{11} , {v}_{11} ) , ( {a}_{13} , {v}_{12} ) , ( {a}_{12} , {v}_{22} ) . \\ M is not perfect . \\ Pick a free vertex S = {a}_{31} . \\ T = O / \\ {N}_{l} ( S ) = O / = T . \\ Find all v ∉ T = \{ {v}_{11} , {v}_{12} , {v}_{21} , {v}_{22} , {v}_{31} \} . \\ Generate new labels . \\ {α}_{1} = l ( {a}_{31} ) + l ( {v}_{11} ) - e ( {a}_{31} , {v}_{11} ) = 0.2$$

$${α}_{2} = l ( {a}_{31} ) + l ( {v}_{12} ) - e ( {a}_{31} , {v}_{12} ) = 0.2$$

$${α}_{3} = l ( {a}_{31} ) + l ( {v}_{21} ) - e ( {a}_{31} , {v}_{21} ) = 0.18$$

$${α}_{4} = l ( {a}_{31} ) + l ( {v}_{22} ) - e ( {a}_{31} , {v}_{22} ) = 0.18$$

$${α}_{4} = l ( {a}_{31} ) + l ( {v}_{31} ) - e ( {a}_{31} , {v}_{31} ) = 0.81$$

$${α}_{l} = min ( {α}_{1} , … , {α}_{4} ) = 0.18$$

$$l ( {a}_{31} ) = 0.63 ;$$

$$Calculate the new equality graph .$$

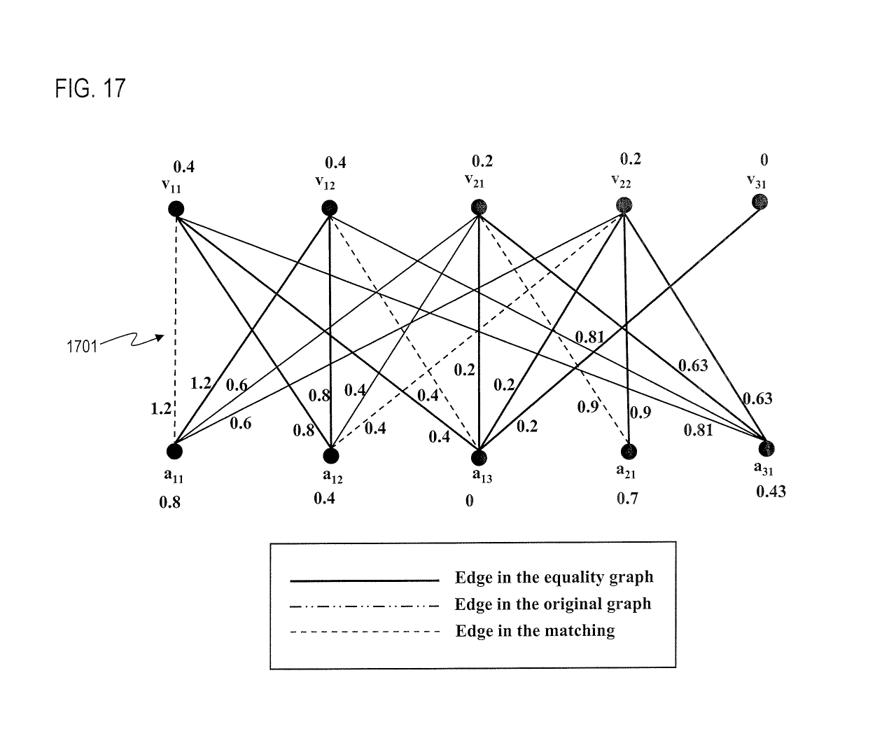

FIG. 17 shows new labels are calculated and a new equality graph 1701 is generated based on the calculation of the new labels.

$$\begin{matrix}M \text{:} ( {a}_{21} , {v}_{21} ) , ( {a}_{11} , {v}_{11} ) , ( {a}_{13} , {v}_{12} ) , ( {a}_{12} , {v}_{22} ) \\ {N}_{l} ( S ) = \{ {v}_{21} , {v}_{22} \} . \\ Pick a y ∈ {N}_{l} ( S ) \text{\textbackslash} T = \{ {v}_{21} , {v}_{22} \} . \\ y = {v}_{21} . \\ {v}_{21} is matched to {a}_{21} so … \\ S = S ⋃ {a}_{21} = \{ {a}_{31} , {a}_{21} \} and \\ T = T ⋃ {v}_{21} = {v}_{22} . \\ {N}_{l} ( S ) = \{ {v}_{21} , {v}_{22} \} \neq T . \\ Pick a y ∈ {N}_{l} ( S ) \text{\textbackslash} T = \{ {v}_{22} \} . \\ {v}_{22} is matched to {a}_{12} so … \\ S = S ⋃ {a}_{12} = \{ {a}_{31} , {a}_{21} , {a}_{12} \} \\ and \\ T = T ⋃ {v}_{22} = \{ {v}_{21} , {v}_{22} \} . \\ {N}_{l} ( S ) = \{ {v}_{11} , {v}_{12} , {v}_{21} , {v}_{22} \} \neq T . \\ Pick a y ∈ {N}_{l} ( S ) \text{\textbackslash} T = \{ {v}_{11} , {v}_{12} \} . \\ y = {v}_{11} . \\ {v}_{11} is matched to {a}_{11} so … \\ S = S ⋃ {a}_{11} = \{ {a}_{31} , {a}_{21} , {a}_{12} , {a}_{11} \} and \\ T = \{ {v}_{21} , {v}_{22} , {v}_{11} \} . \\ {N}_{l} ( S ) = \{ {v}_{11} , {v}_{12} , {v}_{21} , {v}_{22} \} \neq T . \\ Pick a y ∈ {N}_{l} ( S ) \text{\textbackslash} T = \{ {v}_{12} \} . \\ {v}_{12} is matched to {a}_{13 } so … \\ S = S ⋃ {a}_{13} = \{ {a}_{31} , {a}_{21} , {a}_{12} , {a}_{11} , {a}_{13} \} and \\ T = T ⋃ {v}_{12} = \{ {v}_{21} , {v}_{22} , {v}_{11} , {v}_{12} \} . \\ {N}_{l} ( S ) = T . \\ Find all v ∉ T = {v}_{31} . \\ Calculate the new labels . \\ {α}_{1} = l ( {a}_{31} ) + l ( {v}_{31} ) - e ( {a}_{31} , {v}_{31} ) = 0.63 \\ {α}_{2} = l ( {a}_{21} ) + l ( {v}_{31} ) - e ( {a}_{21} , {v}_{31} ) = 0.90 \\ {α}_{3} = l ( {a}_{12} ) + l ( {v}_{31} ) - e ( {a}_{12} , {v}_{31} ) = 0.60 \\ {α}_{4} = l ( {a}_{11} ) + l ( {v}_{31} ) - e ( {a}_{11} , {v}_{31} ) = 1.00 \\ {α}_{5} = l ( {a}_{13} ) + l ( {v}_{31} ) - e ( {a}_{13} , {v}_{31} ) = 0.20 \\ {α}_{l} = min ( {α}_{1} … , {α}_{5} ) = 0.20 \\ l ( {a}_{31} ) = 0.43 ; l ( {a}_{21} ) = 0.70 ; l ( {a}_{12} ) = 0.40 ; l ( {a}_{11} ) = 0.80 ; l ( {a}_{13} ) - 0.00 ; \\ l ( {v}_{11} ) = 0.4 ; l ( {v}_{12} ) = 0.4 ; l ( {v}_{21} ) = 0.2 ; l ( {v}_{22} ) = 0.2 ; \\ Generate the new equality graph .\end{matrix}$$

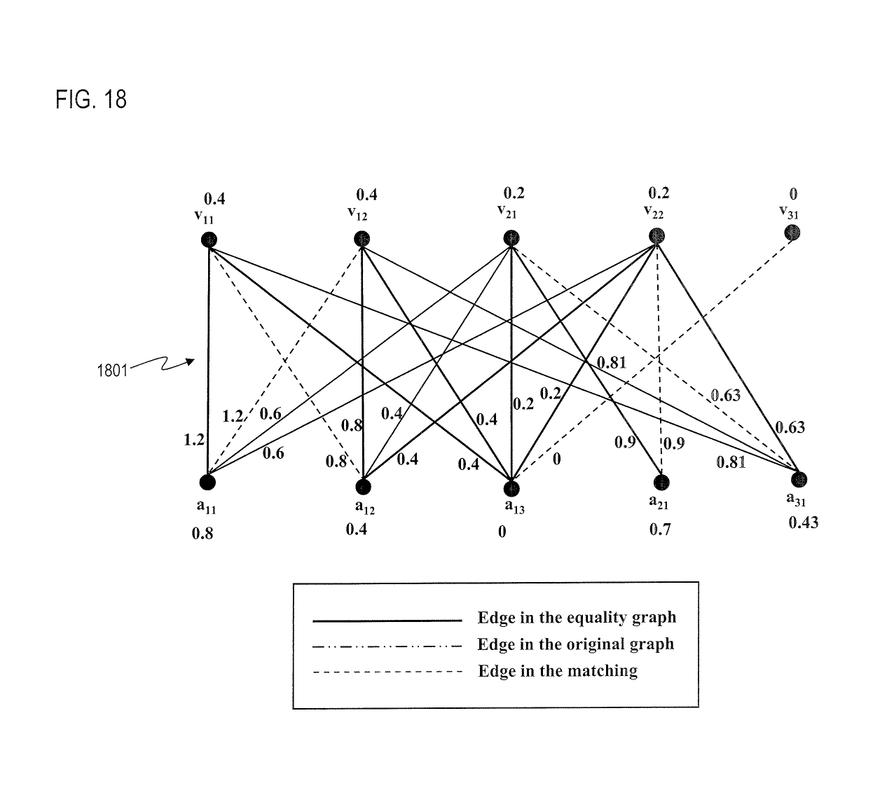

FIG. 18 shows a graph 1801 for final matching (shown within a dotted box) and resulting sub-carrier/power/queue servicing assignment. At this point, the power used on sub-carrier k can be reduced to the minimum necessary to transmit the assigned number of packets:

$$\begin{matrix}M \text{:} ( {a}_{21} , {v}_{21} ) , ( {a}_{11} , {v}_{11} ) , ( {a}_{13} , {v}_{12} ) , ( {a}_{12} , {v}_{22} ) . \\ ( S ) = \{ {a}_{31} , {a}_{21} , {a}_{12} , {a}_{11} , {a}_{13} \} and T = \{ {v}_{21} , {v}_{22} , {v}_{11} , {v}_{12} \} . \\ {N}_{l} ( S ) = \{ {v}_{11} , {v}_{12} , {v}_{21} , {v}_{22} , {v}_{31} \} \neq T . \\ Pick a y ∈ {N}_{l} ( S ) \text{\textbackslash} T = {v}_{31} . \\ {v}_{31} is not matched so T = T ⋃ {v}_{31} = \{ {v}_{21} , {v}_{22} , {v}_{11} , {v}_{12} , {v}_{31} \} . \\ M \text{:} ( {a}_{31} , {v}_{21} ) , ( {a}_{21} , {v}_{22} ) , ( {a}_{12} , {v}_{11} ) , ( {a}_{11} , {v}_{12} ) , ( {a}_{13} , {v}_{22} ) . \\ M is perfect . \\ l ( {a}_{31} ) + l ( {a}_{21} ) + l ( {a}_{12} ) + l ( {a}_{11} ) + l ( {a}_{13} ) + l ( {v}_{21} ) + l ( {v}_{22} ) + l ( {v}_{11} ) + \\ l ( {v}_{12} ) + l ( {v}_{31} ) = 3.53 . \\ e ( {a}_{31} , {v}_{21} ) + e ( {a}_{21} , {v}_{22} ) + e ( {a}_{12} , {v}_{11} ) + e ( {a}_{11} , {v}_{12} ) + \\ e ( {a}_{13} , {v}_{31} ) = 3.53 . \\ Maximum weighted matching has been found .\end{matrix}$$

FIG. 19 shows a system that optimizes sub-carrier, power and queue servicing assignment. Continuing with the example of FIG. 8, queue occupancy at the beginning of the nth downlink frame is shown. Specifically, three packets are stored in Queue #1. In Queue #2, four packets are buffered, while Queue #3 houses one packet.

Upon executing the resource allocation process, sub-carrier assignment results in subcarrier #1 servicing packet 1 from Queue #1 and packet 1 from Queue #3. Subcarrier #2 transports packet 1 from Queue #2 and the packet 2 from the Queue #1.

The above assignments account for optimal power efficiency. After the final assignment, the power used to transmit over each sub-carrier can be reduced to the minimum required to reliably transmit the number of packets that have been allocated for transmission over that sub-carrier. This is true since the original power allocation to the kth sub-carrier is Pₘₐₓ(k). If Pₘₐₓ(k) would result in a waste of power (i.e., if it was more than sufficient to empty the user's queues for all users who could send at least one packet over sub-carrier k), then it would be reduced to the minimum required to send all of the packets that are candidates for transmission over that sub-carrier. After assigning the packets to the sub-carriers, the transmit power can be reduced once more to be the minimum required to send all of the packets that were assigned for transmission over the k-th sub-carrier.

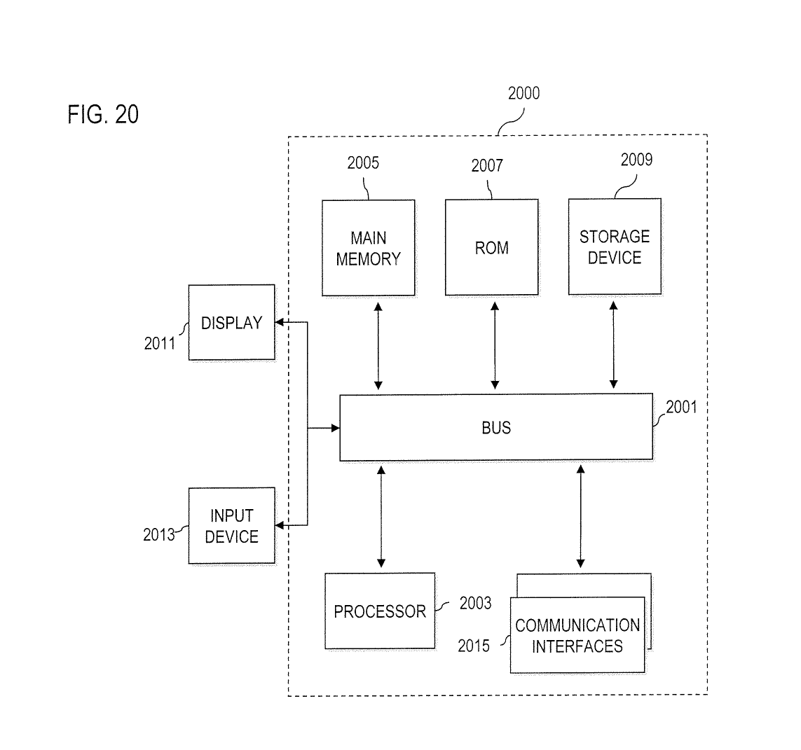

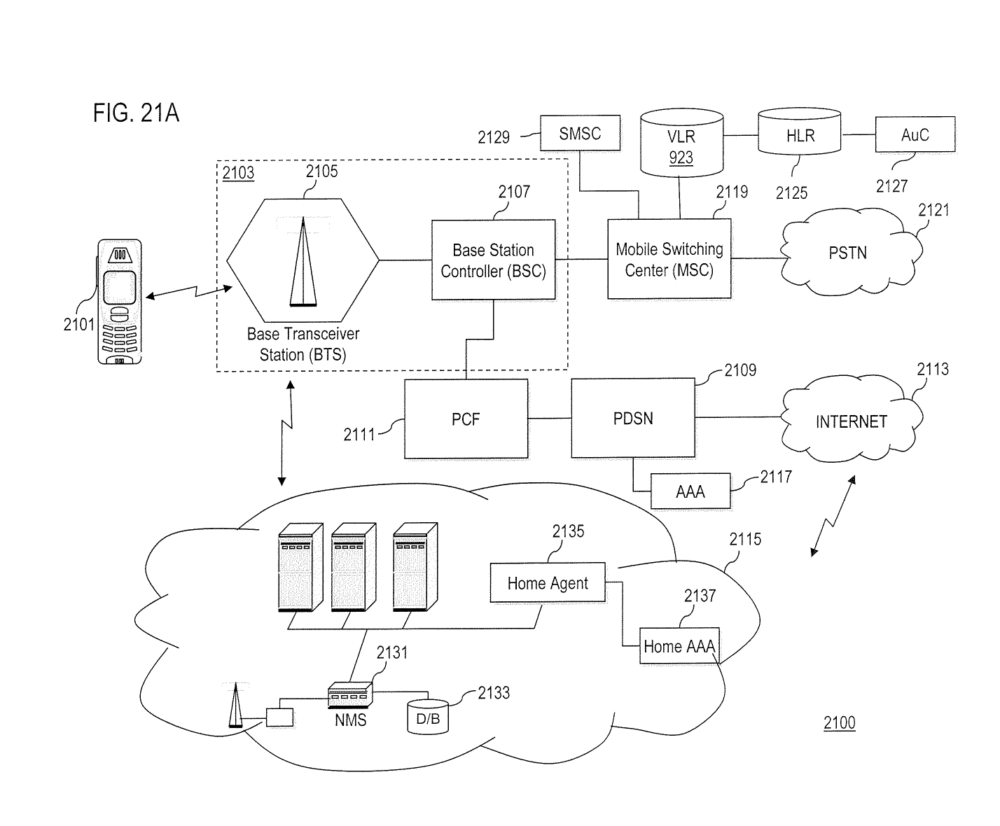

One of ordinary skill in the art would recognize that the processes for providing cross-layer optimization may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 20.

FIG. 20 illustrates exemplary hardware upon which various embodiments of the invention can be implemented. A computing system 2000 includes a bus 2001 or other communication mechanism for communicating information and a processor 2003 coupled to the bus 2001 for processing information. The computing system 2000 also includes main memory 2005, such as a random access memory (RAM) or other dynamic storage device, coupled to the bus 2001 for storing information and instructions to be executed by the processor 2003. Main memory 2005 can also be used for storing temporary variables or other intermediate information during execution of instructions by the processor 2003. The computing system 2000 may further include a read only memory (ROM) 2007 or other static storage device coupled to the bus 2001 for storing static information and instructions for the processor 2003. A storage device 2009, such as a magnetic disk or optical disk, is coupled to the bus 2001 for persistently storing information and instructions.

The computing system 2000 may be coupled via the bus 2001 to a display 2011, such as a liquid crystal display, or active matrix display, for displaying information to a user. An input device 2013, such as a keyboard including alphanumeric and other keys, may be coupled to the bus 2001 for communicating information and command selections to the processor 2003. The input device 2013 can include a cursor control, such as a mouse, a trackball, or cursor direction keys, for communicating direction information and command selections to the processor 2003 and for controlling cursor movement on the display 2011.

According to various embodiments of the invention, the processes described herein can be provided by the computing system 2000 in response to the processor 2003 executing an arrangement of instructions contained in main memory 2005. Such instructions can be read into main memory 2005 from another computer-readable medium, such as the storage device 2009. Execution of the arrangement of instructions contained in main memory 2005 causes the processor 2003 to perform the process steps described herein. One or more processors in a multi-processing arrangement may also be employed to execute the instructions contained in main memory 2005. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 2000 also includes at least one communication interface 2015 coupled to bus 2001. The communication interface 2015 provides a two-way data communication coupling to a network link (not shown). The communication interface 2015 sends and receives electrical, electromagnetic, or optical signals that carry digital data streams representing various types of information. Further, the communication interface 2015 can include peripheral interface devices, such as a Universal Serial Bus (USB) interface, a PCMCIA (Personal Computer Memory Card International Association) interface, etc.

The processor 2003 may execute the transmitted code while being received and/or store the code in the storage device 2009, or other non-volatile storage for later execution. In this manner, the computing system 2000 may obtain application code in the form of a carrier wave.

The term “computer-readable medium” as used herein refers to any medium that participates in providing instructions to the processor 2003 for execution. Such a medium may take many forms, including but not limited to non-volatile media, volatile media, and transmission media. Non-volatile media include, for example, optical or magnetic disks, such as the storage device 2009. Volatile media include dynamic memory, such as main memory 2005. Transmission media include coaxial cables, copper wire and fiber optics, including the wires that comprise the bus 2001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a. RAM, a PROM, and EPROM; a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

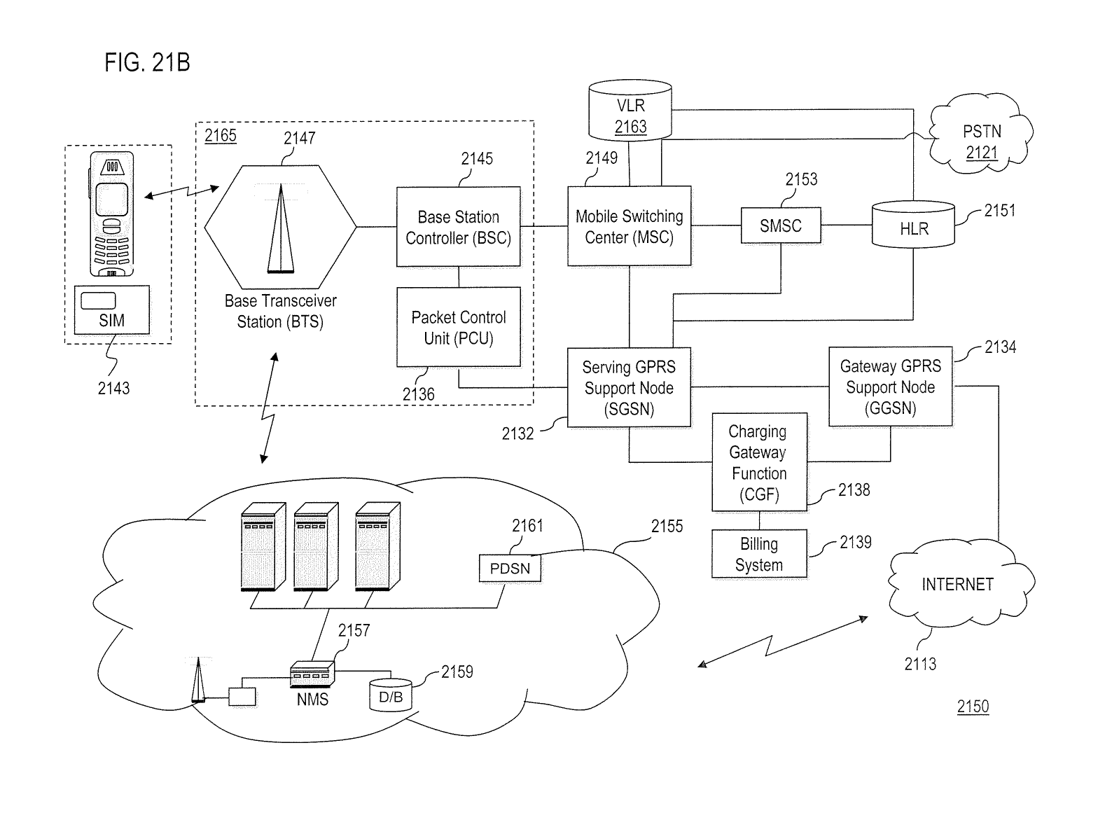

FIGS. 21A and 21B are diagrams of different cellular mobile phone systems capable of supporting various embodiments of the invention. FIGS. 21A and 21B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 2100 includes mobile stations 2101 (e.g., handsets, terminals, stations, units, devices, or any type of interface to the user (such as “wearable” circuitry, etc.)) in communication with a Base Station Subsystem (BSS) 2103. According to one embodiment of the invention, the radio network supports Third Generation (3G) services as defined by the International Telecommunications Union (ITU) for International Mobile Telecommunications 2000 (IMT-2000).

In this example, the BSS 2103 includes a Base Transceiver Station (BTS) 2105 and Base Station Controller (BSC) 2107. Although a single BTS is shown, it is recognized that multiple BTSs are typically connected to the BSC through, for example, point-to-point links. Each BSS 2103 is linked to a Packet Data Serving Node (PDSN) 2109 through a transmission control entity, or a Packet Control Function (PCF) 2111. Since the PDSN 2109 serves as a gateway to external networks, e.g., the Internet 2113 or other private consumer networks 2115, the PDSN 2109 can include an Access, Authorization and Accounting system (AAA) 2117 to securely determine the identity and privileges of a user and to track each user's activities. The network 2115 comprises a Network Management System (NMS) 2131 linked to one or more databases 2133 that are accessed through a Home Agent (HA) 2135 secured by a Home AAA 2137.

Although a single BSS 2103 is shown, it is recognized that multiple BSSs 2103 are typically connected to a Mobile Switching Center (MSC) 2119. The MSC 2119 provides connectivity to a circuit-switched telephone network, such as the Public Switched Telephone Network (PSTN) 2121. Similarly, it is also recognized that the MSC 2119 may be connected to other MSCs 2119 on the same network 2100 and/or to other radio networks. The MSC 2119 is generally collocated with a Visitor Location Register (VLR) 2123 database that holds temporary information about active subscribers to that MSC 2119. The data within the VLR 2123 database is to a large extent a copy of the Home Location Register (HLR) 2125 database, which stores detailed subscriber service subscription information. In some implementations, the HLR 2125 and VLR 2123 are the same physical database; however, the HLR 2125 can be located at a remote location accessed through, for example, a Signaling System Number 7 (SS7) network. An Authentication Center (AuC) 2127 containing subscriber-specific authentication data, such as a secret authentication key, is associated with the HLR 2125 for authenticating users. Furthermore, the MSC 2119 is connected to a Short Message Service Center (SMSC) 2129 that stores and forwards short messages to and from the radio network 2100.

During typical operation of the cellular telephone system, BTSs 2105 receive and demodulate sets of reverse-link signals from sets of mobile units 2101 conducting telephone calls or other communications. Each reverse-link signal received by a given BTS 2105 is processed within that station. The resulting data is forwarded to the BSC 2107. The BSC 2107 provides call resource allocation and mobility management functionality including the orchestration of soft handoffs between BTSs 2105. The BSC 2107 also routes the received data to the MSC 2119, which in turn provides additional routing and/or switching for interface with the PSTN 2121. The MSC 2119 is also responsible for call setup, call termination, management of inter-MSC handover and supplementary services, and collecting, charging and accounting information. Similarly, the radio network 2100 sends forward-link messages. The PSTN 2121 interfaces with the MSC 2119. The MSC 2119 additionally interfaces with the BSC 2107, which in turn communicates with the BTSs 2105, which modulate and transmit sets of forward-link signals to the sets of mobile units 2101.

As shown in FIG. 21B, the two key elements of the General Packet Radio Service (GPRS) infrastructure 2150 are the Serving GPRS Supporting Node (SGSN) 2132 and the Gateway GPRS Support Node (GGSN) 2134. In addition, the GPRS infrastructure includes a Packet Control Unit PCU (2136) and a Charging Gateway Function (CGF) 2138 linked to a Billing System 2139. A GPRS the Mobile Station (MS) 2141 employs a Subscriber Identity Module (SIM) 2143.

The PCU 2136 is a logical network element responsible for GPRS-related functions such as air interface access control, packet scheduling on the air interface, and packet assembly and re-assembly. Generally the PCU 2136 is physically integrated with the BSC 2145; however, it can be collocated with a BTS 2147 or a SGSN 2132. The SGSN 2132 provides equivalent functions as the MSC 2149 including mobility management, security, and access control functions but in the packet-switched domain. Furthermore, the SGSN 2132 has connectivity with the PCU 2136 through, for example, a Frame Relay-based interface using the BSS GPRS protocol (BSSGP). Although only one SGSN is shown, it is recognized that that multiple SGSNs 2131 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 2145, any given BSC 2145 generally interfaces with one SGSN 2132. Also, the SGSN 2132 is optionally connected with the HLR 2151 through an SS7-based interface using GPRS enhanced Mobile Application Part (MAP) or with the MSC 2149 through an SS7-based interface using Signaling Connection Control Part (SCCP). The SGSN/HLR interface allows the SGSN 2132 to provide location updates to the HLR 2151 and to retrieve GPRS-related subscription information within the SGSN service area. The SGSN/MSC interface enables coordination between circuit-switched services and packet data services such as paging a subscriber for a voice call. Finally, the SGSN 2132 interfaces with a SMSC 2153 to enable short messaging functionality over the network 2150.

The GGSN 2134 is the gateway to external packet data networks, such as the Internet 2113 or other private customer networks 2155. The network 2155 comprises a Network Management System (NMS) 2157 linked to one or more databases 2159 accessed through a PDSN 2161. The GGSN 2134 assigns Internet Protocol (IP) addresses and can also authenticate users acting as a Remote Authentication Dial-In User Service host. Firewalls located at the GGSN 2134 also perform a firewall function to restrict unauthorized traffic. Although only one GGSN 2134 is shown, it is recognized that a given SGSN 2132 may interface with one or more GGSNs 2133 to allow user data to be tunneled between the two entities as well as to and from the network 2150. When external data networks initialize sessions over the GPRS network 2150, the GGSN 2134 queries the HLR 2151 for the SGSN 2132 currently serving a MS 2141.

The BTS 2147 and BSC 2145 manage the radio interface, including controlling which Mobile Station (MS) 2141 has access to the radio channel at what time. These elements essentially relay messages between the MS 2141 and SGSN 2132. The SGSN 2132 manages communications with an MS 2141, sending and receiving data and keeping track of its location. The SGSN 2132 also registers the MS 2141, authenticates the MS 2141, and encrypts data sent to the MS 2141.

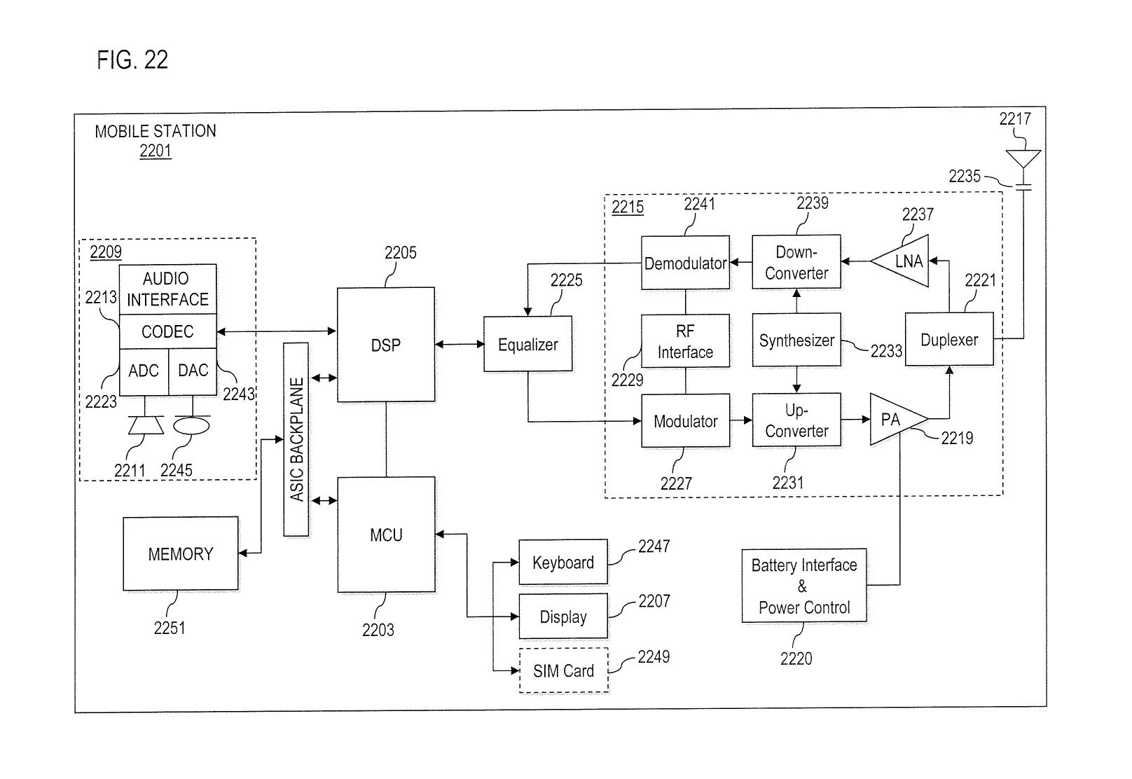

FIG. 22 is a diagram of exemplary components of a mobile station (e.g., handset) capable of operating in the systems of FIGS. 21A and 21B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 2203, a Digital Signal Processor (DSP) 2205, and a receiver/transmitter unit including a microphone gain control unit and a sneaker gain control unit. A main display unit 2207 provides a display to the user in support of various applications and mobile station functions. An audio function circuitry 2209 includes a microphone 2211 and microphone amplifier that amplifies the speech signal output from the microphone 2211. The amplified speech signal output from the microphone 2211 is fed to a coder/decoder (CODEC) 2213.

A radio section 2215 amplifies power and converts frequency in order to communicate with a base station, which is included in a mobile communication system (e.g., systems of FIG. 21A or 21B), via antenna 2217. The power amplifier (PA) 2219 and the transmitter/modulation circuitry are operationally responsive to the MCU 2203, with an output from the PA 2219 coupled to the duplexer 2221 or circulator or antenna switch, as known in the art. The PA 2219 also couples to a battery interface and power control unit 2220.

In use, a user of mobile station 2201 speaks into the microphone 2211 and his or her voice along with any detected background noise is converted into an analog voltage. The analog voltage is then converted into a digital signal through the Analog to Digital Converter (ADC) 2223. The control unit 2203 routes the digital signal into the DSP 2205 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 2225 for compensation of any frequency-dependent impairments that occur during transmission though the air such as phase and amplitude distortion. After equalizing the bit stream, the modulator 2227 combines the signal with a RF signal generated in the RF interface 2229. The modulator 2227 generates a sine wave by way of frequency or phase modulation. In order to prepare the signal for transmission, an up-converter 2231 combines the sine wave output from the modulator 2227 with another sine wave generated by a synthesizer 2233 to achieve the desired frequency of transmission. The signal is then sent through a PA 2219 to increase the signal to an appropriate power level. In practical systems, the PA 2219 acts as a variable gain amplifier whose gain is controlled by the DSP 2205 from information received from a network base station. The signal is then filtered within the duplexer 2221 and optionally sent to an antenna coupler 2235 to match impedances to provide maximum power transfer. Finally, the signal is transmitted via antenna 2217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 2201 are received via antenna 2217 and immediately amplified by a low noise amplifier (LNA) 2237. A down-converter 2239 lowers the carrier frequency while the demodulator 2241 strips away the RF leaving only a digital bit stream. The signal then goes through the equalizer 2225 and is processed by the DSP 2205. A Digital to Analog Converter (DAC) 2243 converts the signal and the resulting output is transmitted to the user through the speaker 2245, all under control of a Main Control Unit (MCU) 2203—which can be implemented as a Central Processing Unit (CPU) (not shown).

The MCU 2203 receives various signals including input signals from the keyboard 2247. The MCU 2203 delivers a display command and a switch command to the display 2207 and to the speech output switching controller, respectively. Further, the MCU 2203 exchanges information with the DSP 2205 and can access an optionally incorporated SIM card 2249 and a memory 2251. In addition, the MCU 2203 executes various control functions required of the station. The DSP 2205 may, depending upon the implementation, perform any of a variety of conventional digital processing functions on the voice signals. Additionally, DSP 2205 determines the background noise level of the local environment from the signals detected by microphone 2211 and sets the gain of microphone 2211 to a level selected to compensate for the natural tendency of the user of the mobile station 2201.

The CODEC 2213 includes the ADC 2223 and DAC 2243. The memory 2251 stores various data including call incoming tone data and is capable of storing other data including music data received via, e.g., the global Internet. The software module could reside in RAM memory, flash memory, registers, or any other form of writable storage medium known in the art. The memory device 2251 may be, but not limited to, a single memory, CD, DVD, ROM, RAM, EEPROM, optical storage, or any other non-volatile storage medium capable of storing digital data.

An optionally incorporated SIM card 2249 carries, for instance, important information, such as the cellular phone number, the carrier supplying service, subscription details, and security information. The SIM card 2249 serves primarily to identify the mobile station 2201 on a radio network. The card 2249 also contains a memory for storing a personal telephone number registry, text messages, and user specific mobile station settings.

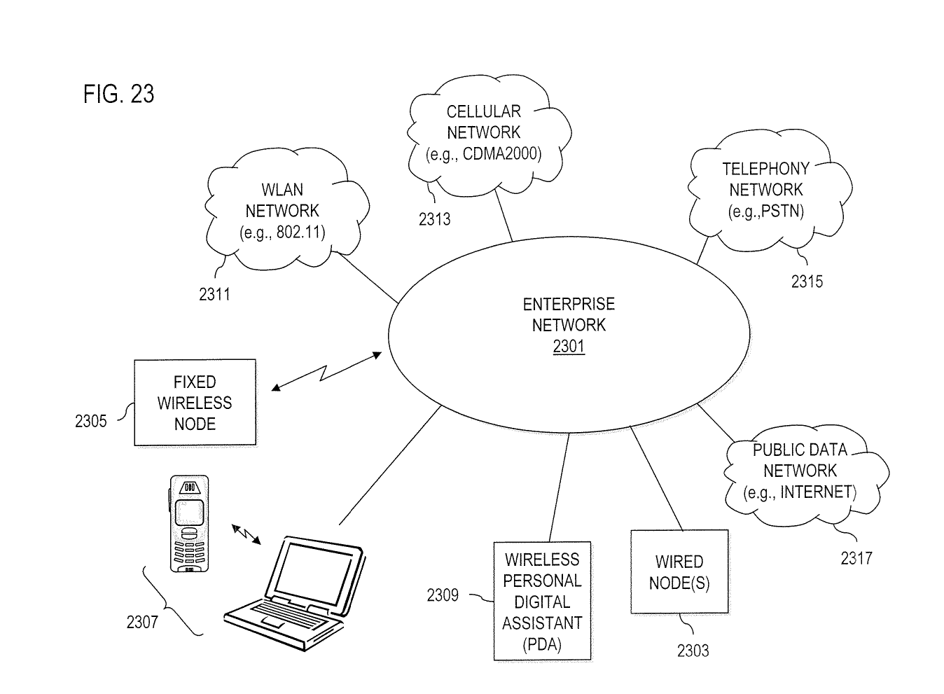

FIG. 23 shows an exemplary enterprise network, which can be any type of data communication network utilizing packet-based and/or cell-based technologies (e.g., Asynchronous Transfer Mode (ATM), Ethernet, IP-based, etc.). The enterprise network 2301 provides connectivity for wired nodes 2303 as well as wireless nodes 2305-2309 (fixed or mobile), which are each configured to perform the processes described above. The enterprise network 2301 can communicate with a variety of other networks, such as a WLAN network 2311 (e.g., IEEE 802.11), a cdma2000 cellular network 2313, a telephony network 2316 (e.g., PSTN), or a public data network 2317 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining queuing state information of a queue;
determining channel state information of a channel of a wireless network; and
allocating transmission resources to a plurality of wireless devices based on the queuing state information and the channel state information, each of the wireless devices being configured to operate over the wireless network,
wherein the allocation is performed according to a utility-based cross-layer resource management framework that transforms a utility function into an equivalent bipartite graph to concurrently maximize throughput and fairness in servicing the queue.

2. A method according to claim 1, further comprising:
determining a transmission power level for reliable transmission over the channel, wherein the allocation is further based on the transmission power level.

3. A method according to claim 1, wherein the framework provides cross-layer Medium Access Control (MAC) layer and physical (PHY) layer optimization.

4. A method according to claim 1, wherein the transmission resources include a plurality of sub-carriers.

5. A method according to claim 1, wherein the channel is compliant with an Orthogonal Frequency Division Multiple Access (OFDMA) scheme.

6. A method according to claim 5, wherein the queue is configured to buffer a plurality of packets corresponding to the respective wireless devices, the method further comprising:
transmitting multiple ones of the packets using one of the sub-carriers during an OFDMA frame.

7. An apparatus comprising:
a queue;
a channel conditioner configured to determine channel state information of a channel of a wireless network; and
a scheduler configured to allocate transmission resources to a plurality of wireless devices based on state information of the queue and the channel state information, each of the wireless devices being configured to operate over the wireless network
wherein the allocation is performed according to a utility-based cross-layer resource management framework that transforms a utility function into an equivalent bipartite graph to concurrently maximize throughput and fairness in servicing the queue.

8. An apparatus according to claim 7, wherein the allocation is further based on a transmission power level associated with reliable transmission over the channel.

9. An apparatus according to claim 7, wherein the framework provides cross-layer Medium Access Control (MAC) layer and physical (PHY) layer optimization.

10. An apparatus according to claim 7, wherein the transmission resources include a plurality of sub-carriers.

11. An apparatus according to claim 7, wherein the channel is compliant with an Orthogonal Frequency Division Multiple Access (OFDMA) scheme.

12. An apparatus according to claim 11, wherein the queue is configured to buffer a plurality of packets corresponding to the respective wireless devices, the apparatus further comprising:
a transceiver configured to transmit multiple ones of the packets using one of the sub-carriers during an OFDMA frame.

13. An apparatus according to claim 7, wherein the apparatus is a base station, and one of the wireless devices is a handset.

14. A method comprising:
receiving a resource allocation over a wireless network, wherein the resource allocation is among a plurality of resource allocations performed according to a utility-based cross-layer resource management framework that transforms a utility function into an equivalent bipartite graph to concurrently maximize throughput and fairness in servicing a queue, the resource allocation being based on the queuing state information and channel state information correspond to a channel of the wireless network.

15. A method according to claim 14, wherein the allocation is further based on a transmission power level associated with reliable transmission over the channel.

16. A method according to claim 14, wherein the framework provides cross-layer Medium Access Control (MAC) layer and physical (PHY) layer optimization.

17. A method according to claim 14, wherein the transmission resources include a plurality of sub-carriers.

18. A method according to claim 14, wherein the channel is compliant with an Orthogonal Frequency Division Multiple Access (OFDMA) scheme.

19. A method according to claim 18, wherein the queue is configured to buffer a plurality of packets corresponding to the respective wireless devices, the method further comprising:
receiving multiple ones of the packets using one of the sub-carriers during an OFDMA frame.

20. An apparatus comprising:
a processor configured to receive a resource allocation over a wireless network, wherein the resource allocation is among a plurality of resource allocations performed according to a utility-based cross-layer resource management framework that transforms a utility function into an equivalent bipartite graph to concurrently maximize throughput and fairness in servicing a queue, the resource allocation being based on the queuing state information and channel state information correspond to a channel of the wireless network.

21. An apparatus according to claim 20, wherein the allocation is further based on a transmission power level associated with reliable transmission over the channel.

22. An apparatus according to claim 20, wherein the framework provides cross-layer Medium Access Control (MAC) layer and physical (PHY) layer optimization.

23. An apparatus according to claim 20, wherein the transmission resources include a plurality of sub-carriers.

24. An apparatus according to claim 20, wherein the channel is compliant with an Orthogonal Frequency Division Multiple Access (OFDMA) scheme.

25. An apparatus according to claim 24, wherein the queue is configured to buffer a plurality of packets corresponding to the respective wireless devices, the apparatus further comprising:
a transceiver configured to receive multiple ones of the packets using one of the sub-carriers during an OFDMA frame.
